(19) United States
(12) Patent Application Publication
(10) Pub. No.: US 2014/0028841 A1
(43) Pub. Date: Jan. 30, 2014

(54) MONITORING DEVICE MOUNTING SYSTEM

(71) Applicant: WREN ASSOCIATES, LTD., Jefferson City, MO (US)

(72) Inventors: Corey Ray Case, Ashland, MO (US); Fay Ann Schulte, Tebbetts, MO (US); Jason Gregory Lockett, Columbia, MO (US); Timothy Edwin Morrow, Jefferson City, MO (US); Anthony Winkelman, Hartsburg, MO (US)

(73) Assignee: WREN ASSOCIATES, LTD., Jefferson City, MO (US)

(21) Appl. No.: 13/668,711

(22) Filed: Nov. 5, 2012

Related U.S. Application Data
(60) Provisional application No. 61/677,160, filed on Jul. 30, 2012.

(51) Int. Cl. H04N 7/18

(52) U.S. Cl. CPC H04N 7/18
USPC 348/143

(57) ABSTRACT

A monitoring device mounting system such as a shelf mounted theft detection and deterrent surveillance system is provided. A monitoring device can be mounted or coupled to an existing structure in a display, such as a shelf or display wall, using pre-existing elements of the structure to secure mounting with the monitoring device mounting system. The monitoring device mounting system can include various configurations such as over shelf, under self, coupled to a display wall, or over a display wall.

### PRIORITY CLAIM

This application claims the benefit of previously filed U.S. Provisional patent application entitled “SHELF MOUNTED THEFT DETECTION AND DETERRENT SURVEILLANCE SYSTEM,” assigned U.S. Ser. No. 61/677,160, filed Jul. 30, 2012, and which is incorporated herein by reference for all purposes.

### FIELD OF THE SUBJECT MATTER

The presently disclosed subject matter relates in general to monitoring systems, and more particularly to shelf mounted surveillance systems for theft detection and deterrence.

### BACKGROUND OF THE SUBJECT MATTER

Retail establishments such as retail stores, department stores, and grocery stores, utilize surveillance systems to prevent and deter theft. Typically, such surveillance systems include video cameras and monitoring devices for viewing surveillance footage. Installation of such systems can be cumbersome and expensive due to extensive installation hardware. Further, an installation professional can be needed to install the cameras and monitoring devices. Moreover, monitoring of theft or suspicious activity can be reduced due to limitations in camera mounting locations on the premises.

In a conventional approach, a surveillance camera is mounted on a pegboard portion of a display. This type of surveillance camera is limited by the line of sight of the camera and the availability of pegboard in the display. In addition, the camera is merely placed in the pegboard and not secured in place thus increasing the risk of someone dislodging or removing the camera.

Thus, a need exists for an improved surveillance mounting system. More particularly, it would be desirable to have a surveillance mounting system that can be mounted to a retail shelf without professional installers in order to reduce cost and complexity of installation. While various implementations of surveillance systems have been developed, no design has emerged that generally encompasses all of the desired characteristics as hereafter presented in accordance with the subject technology.

### BRIEF DESCRIPTION OF THE SUBJECT MATTER

The presently disclosed subject matter recognizes and variously addresses the foregoing issues, and others concerning certain aspects of surveillance systems. Thus, broadly speaking, an object of certain embodiments of the present disclosure is to provide improved designs for certain components and component assemblies associated with surveillance systems, and to provide improved shelf mounted detection and deterrent devices for surveillance systems.

Aspects and advantages of the presently disclosed subject matter will be set forth in part in the following description, or may be apparent from the description, or may be learned through practice of the presently disclosed subject matter, which relates in some presently disclosed embodiments to an improved shelf mounted device for various monitoring systems such as a surveillance system.

In one presently disclosed embodiment, a monitoring device can be coupled to an existing shelf using a monitoring device mounting system. In particular, the monitoring device can be coupled to a bracket using a support arm that projects over the shelf.

In another presently disclosed variation of the foregoing, a monitoring device can be coupled under an existing structure such as a shelf with a monitoring device mounting system. Brackets can support a telescoping support arm such that the monitoring device can selectively extend from the shelf.

In another presently disclosed embodiment, a monitoring device can be mounted to a display using a monitoring device mounting system. A support arm can be coupled between the monitoring device and the wall plate bracket and the wall plate bracket can be inserted into existing vertically mounted shelf supports.

In some presently disclosed embodiments, a monitoring device can include a single display and a single monitoring device coupled to a monitoring device mounting system. Alternatively, two monitoring devices can be configured such that the two devices are coupled in rear-facing arrangement to a monitoring device mounting system.

In another presently disclosed embodiment, a monitoring device can be mounted over a portion of a wall of a retail display with a monitoring device mounting system.

In another presently disclosed embodiment, a monitoring device can include a camera or pair of cameras mounted to preexisting support elements with a monitoring device mounting system that includes a bracket. Alternatively, the camera or cameras can be disposed in a housing and coupled to a monitoring device mounting system having a support mounted under the shelf.

In still another presently disclosed embodiment, a camera can be mounted on a wall of a retail display with a monitoring device mounting system. The monitoring device mounting system can include with a wraparound bracket that inserts into a preexisting groove on the display wall.

In still another presently disclosed embodiment, a camera can be mounted on a post or wall of a retail display with a monitoring device mounting system. The monitoring device mounting system can include with a bracket that can be mounted to the post or wall.

In one presently disclosed exemplary embodiment, a monitoring device mounting system is provided for supporting a monitoring device on a display, the monitoring device mounting system defining a vertical direction, a lateral direction, and a transverse direction, the vertical, lateral, and transverse directions being mutually perpendicular, such monitoring device mounting system preferably comprising monitoring device housing for supporting the monitoring device thereon; support arm means and mounting bracket means. Preferably, such support arm means are provided for supporting such monitoring device housing; and such mounting bracket means are provided for mounting such support arm means to the display.

In one exemplary arrangement of the foregoing, such monitoring device housing may comprise respective laterally spaced front and rear portions, with such monitoring device housing front portion and such monitoring device housing rear portion having respective widths along the transverse direction, and with the width of such monitoring device housing front portion being less than the width of such monitoring device housing rear portion.

In other presently disclosed alternatives of the foregoing, such support arm means may comprise respective laterally spaced first and second end portions, with such monitoring device housing mounted to such support arm first end portion and such mounting bracket means mounted at such support arm second end portion. In some such embodiments, such support arm first and second end portions each may extend longitudinally along the vertical direction.

In still other alternatives thereof, such mounting bracket means may comprise a back brace and a front brace mounted to each other, with such back brace and such front brace having respective coplanar bottom surfaces, configured for resting on a top surface of an associated shelf.

In yet others, such mounting bracket means may comprise a plurality of projections mounted to such mounting bracket means, with each projection of such projections configured for receipt within a respective one of a plurality of holes defined by the display.

Yet for other alternatives of the foregoing monitoring device mounting system, such mounting bracket means may define holes for receipt of fasteners.

In still others, such fasteners may include a plate having projections that extend downwardly along the vertical direction, the projections of such plate insertable through the display and the holes of such mounting bracket means.

For some other alternative embodiments of the foregoing exemplary monitoring device mounting system, such mounting bracket means may comprise a pair of brackets having respective top surfaces, configured for positioning on a bottom surface of an associated shelf.

In other alternative such monitoring device mounting system embodiments, such support arm means may comprise a first portion and a second portion, with such first portion slidably received within such second portion such that such second portion supports such first portion, and with such monitoring device housing mounted to such first portion.

In yet other presently disclosed variations, such mounting bracket means may have a back surface and a plurality of projections mounted at the back surface, with such projections configured for receipt within openings defined by the display. In some further variations, the mounting bracket means may be configured for mounting the support arm means to existing features of the display, while in some instances configured for mounting the support arm means to the display without modifying the display.

Yet another presently disclosed exemplary embodiment relates to a monitoring device mounting system for supporting a monitoring device on a display, the monitoring device mounting system defining a vertical direction, a lateral direction, and a transverse direction, the vertical, lateral, and transverse directions being mutually perpendicular, the monitoring device mounting system comprising a monitoring device housing for supporting the monitoring device thereon; and mounting bracket means for mounting such monitoring device housing to the display.

In some such monitoring device mounting system embodiments, such mounting bracket means may comprise a front plate mounted to a transversely extending top plate, and configured for resting on a top surface of the display.

In others thereof, such mounting bracket means may have a top surface, configured for selective mounting on a bottom surface of an associated shelf. In some of such alternatives, such mounting bracket means may comprise a top plate defining the top surface, a bottom plate spaced apart from such top plate along the vertical direction, and a vertically extending side plate extending between and connecting such top plate and such bottom plate.

In other present variations of presently disclosed monitoring device mounting systems, such mounting bracket means may comprise a front mounting bracket and a rear mounting bracket having respective transversely spaced rear surfaces, configured for resting on the display, with such front and rear mounting brackets mounted to each other.

In yet other alternatives, such mounting bracket means may comprise a display mounting bracket having respective transversely spaced front and back surfaces, with the display mounting bracket back surface configured for resting on the display.

For other variations, such mounting bracket means may comprise a camera mounting bracket mounted to such display mounting bracket at the display mounting bracket front surface and a camera housing mounted to such display mounting bracket and defining a chamber, with such display mounting bracket and such camera mounting bracket disposed within the chamber of such camera housing. In some further variations, the mounting bracket means may be configured for mounting the monitoring device housing to existing features of the display, while in some instances configured for mounting the monitoring device housing to the display without modifying the display.

Yet another presently disclosed exemplary embodiment relates to a monitoring device mounting system for supporting a monitoring device on shelf of a display, the monitoring device mounting system defining a vertical direction, a lateral direction, and a transverse direction, the vertical, lateral, and transverse directions being mutually perpendicular, with such monitoring device mounting system preferably comprising a monitoring device housing for supporting the monitoring device thereon; a support arm having respective laterally spaced first and second end portions, with such monitoring device housing mounted to such support arm first end portion; and a mounting bracket configured for selective mounting on a top surface of an associated shelf, with such mounting bracket mounted at such support arm second end portion, and with such mounting bracket having a back brace and a front brace mounted to each other, and with such back brace and such front brace having respective coplanar bottom surfaces, configured for resting on the top surface of the associated shelf.

Additional objects and advantages of the presently disclosed subject matter are set forth in, or will be apparent to those of ordinary skill in the art from, the detailed description herein. Also, it should be further appreciated by those of ordinary skill in the art that modifications and variations to the specifically illustrated, referenced, and discussed features and/or steps hereof may be practiced in various embodiments and uses of the disclosed technology without departing from the spirit and scope thereof, by virtue of present reference thereto. Such variations may include, but are not limited to, substitution of equivalent means, steps, features, or materials for those shown, referenced, or discussed, and the functional, operational, or positional reversal of various parts, features, steps, or the like.

Still further, it is to be understood that different embodiments, as well as different presently preferred embodiments, of this technology may include various combinations or configurations of presently disclosed steps, features or elements, or their equivalents (including combinations of features, configurations, or steps thereof not expressly shown in the figures or stated in the detailed description).

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

A full and enabling disclosure of the present presently disclosed subject matter, including the best mode thereof, directed to one of ordinary skill in the art, is set forth in the specification, which makes reference to the appended figures, in which:

FIG. 1 provides a perspective view of a monitoring device mounting system according to an exemplary embodiment of the present disclosure;

FIG. 2 provides an exploded view of the monitoring device mounting system of FIG. 1;

FIG. 3 provides a perspective view of the monitoring device mounting system of FIG. 1;

FIG. 4 provides a perspective view of the monitoring device mounting system of FIG. 1;

FIG. 5 provides a perspective view of a monitoring device mounting system according to an additional exemplary embodiment of the present disclosure;

FIG. 6 provides an exploded view of the monitoring device mounting system of FIG. 5;

FIG. 7 provides a perspective view of the monitoring device mounting system of FIG. 5;

FIG. 8 provides a perspective view of the monitoring device mounting system of FIG. 5;

FIG. 9 provides a perspective view of a monitoring device mounting system according to another exemplary embodiment of the present disclosure;

FIG. 10 provides an exploded view of the monitoring device mounting system of FIG. 9;

FIG. 11 provides a perspective view of the monitoring device mounting system of FIG. 9;

FIG. 12 provides a perspective view of the monitoring device mounting system of FIG. 9;

FIG. 13 provides a perspective view of a monitoring device housing according to an exemplary embodiment of the present disclosure with a monitoring device mounted thereto;

FIG. 14 provides an exploded view of the monitoring device housing of FIG. 13;

FIG. 15 provides a perspective view of a monitoring device housing according to an exemplary embodiment of the present disclosure with a pair of monitoring devices mounted thereto;

FIG. 16 provides an exploded view of the monitoring device housing of FIG. 15;

FIG. 17 provides an elevation view of a monitoring device mounting system according to yet another exemplary embodiment of the present disclosure;

FIG. 18 provides a perspective view of the monitoring device mounting system of FIG. 17;

FIG. 19 provides a perspective view of a monitoring device mounting system according to still another exemplary embodiment of the present disclosure;

FIG. 20 provides an exploded view of the monitoring device mounting system of FIG. 19;

FIG. 21 a perspective view of the monitoring device mounting system of FIG. 19;

FIG. 22 provides a perspective view of a monitoring device mounting system according to another additional exemplary embodiment of the present disclosure;

FIG. 23 provides an exploded view of the monitoring device mounting system of FIG. 22;

FIG. 24 provides a perspective view of the monitoring device mounting system of FIG. 22;

FIG. 25 provides a perspective view of a monitoring device mounting system according to yet another additional exemplary embodiment of the present disclosure;

FIG. 26 provides a perspective view of the monitoring device mounting system of FIG. 25;

FIG. 27 provides a perspective view of the monitoring device mounting system of FIG. 25;

FIG. 28 provides a perspective view of a monitoring device mounting system according to still another additional exemplary embodiment of the present disclosure;

FIG. 29 provides an exploded view of the monitoring device mounting system of FIG. 27;

FIG. 30 provides a rear, perspective view of the monitoring device mounting system of FIG. 27;

FIG. 31 provides an exploded view of a monitoring device mounting system according to a further exemplary embodiment of the present disclosure;

FIG. 32 provides a perspective view of the monitoring device mounting system of FIG. 31;

FIG. 33 provides a perspective view of a monitoring device mounting system according to another further exemplary embodiment of the present disclosure;

FIG. 34 provides an exploded view of the exemplary monitoring device system of FIG. 33;

FIG. 35 provides a perspective view of a monitoring device mounting system according to yet another further exemplary embodiment of the present disclosure; and

FIG. 36 provides an exploded view of the exemplary monitoring device mounting system of FIG. 35.

Repeat use of reference characters throughout the present specification and appended drawings is intended to represent same or analogous features, elements, or steps of the presently disclosed subject matter.

### DETAILED DESCRIPTION

Reference is made herewith in detail to embodiments of the presently disclosed subject matter, one or more examples of which are illustrated in the subject drawings. Each example is provided by way of explanation of the presently disclosed subject matter, not limitation of the presently disclosed subject matter. In fact, it will be apparent to those skilled in the art that various modifications and variations can be made in the presently disclosed subject matter without departing from the scope or spirit of the presently disclosed subject matter. For instance, features illustrated or described as part of one embodiment can be used with another embodiment to yield a still further embodiment. Thus, it is intended that the presently disclosed subject matter covers such modifications and variations as come within the scope of the broader disclosure herewith.

Generally, the present disclosure is directed to monitoring device mounting systems such as a shelf-mounted theft detection and deterrent surveillance systems. A monitoring device can include a display and a camera positioned to monitor the length of an aisle. One, two, or more monitoring devices can be mounted with the monitoring device mounting system. The monitoring device mounting system can be coupled to an existing structure in a display, such as a shelf or display wall, using pre-existing elements of the structure to secure mounting. The monitoring device mounting system can include various configurations such as over a shelf, under a shelf, coupled to a display wall, or over a display wall. A support arm can be included in the monitoring device mounting system. The support arm can have various shapes and configurations including telescoping elements to allow adjustments. In addition, the support arm can also be a housing for the electrical cords coupled to the monitoring device.

The monitoring device can alternatively include a camera arrangement coupled to a pre-existing element of a retail structure. For instance, the camera arrangement can be mounted to a shelf and angled with respect to the shelf or parallel to a shelf, in a housing coupled to a shelf, or mounted on a display wall. The camera arrangements can be mounted using a monitoring device mounting system having various configurations, where the monitoring device mounting system minimally interferes with the products in the retail display. For instance, the monitoring device mounting system can include a bracket and/or a housing. Mounting the monitoring device to the pre-existing element of the retail structure can be performed using basic tools such as a screwdriver.

According to aspects of the present disclosure, a monitoring device mounting system can be mounted to a pre-existing structure such as a retail self or display wall without the need for a professional installer. The monitoring device mounting system can minimally interfere with articles displayed on the pre-existing structure. Coupling elements, such as threaded fasteners can be used such that basic tools can be implemented in mounting the monitoring device mounting system to the pre-existing structure.

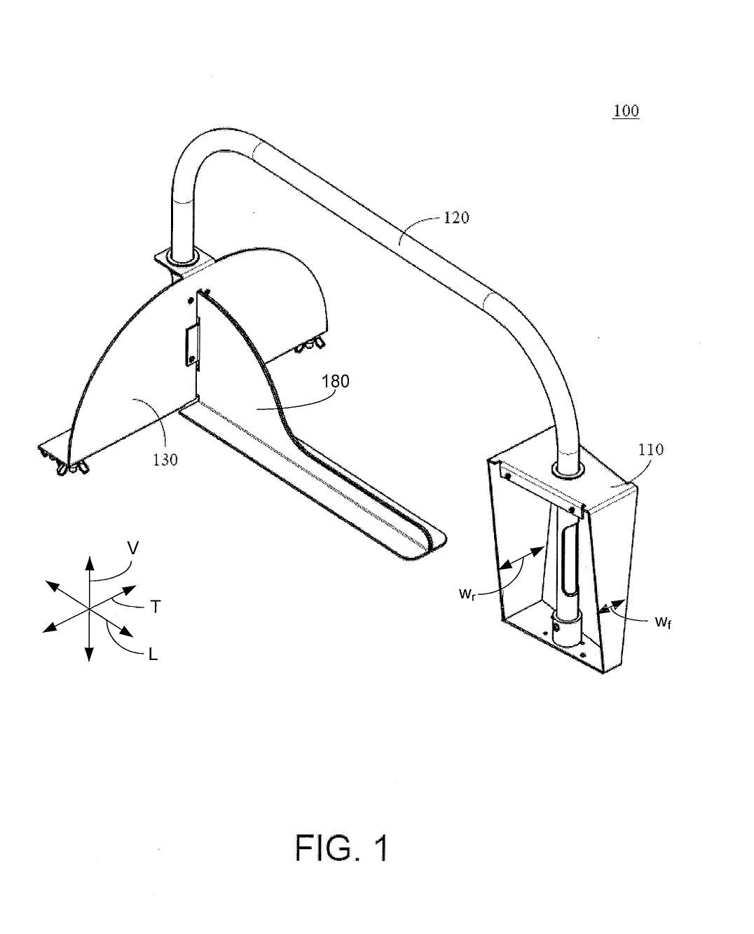

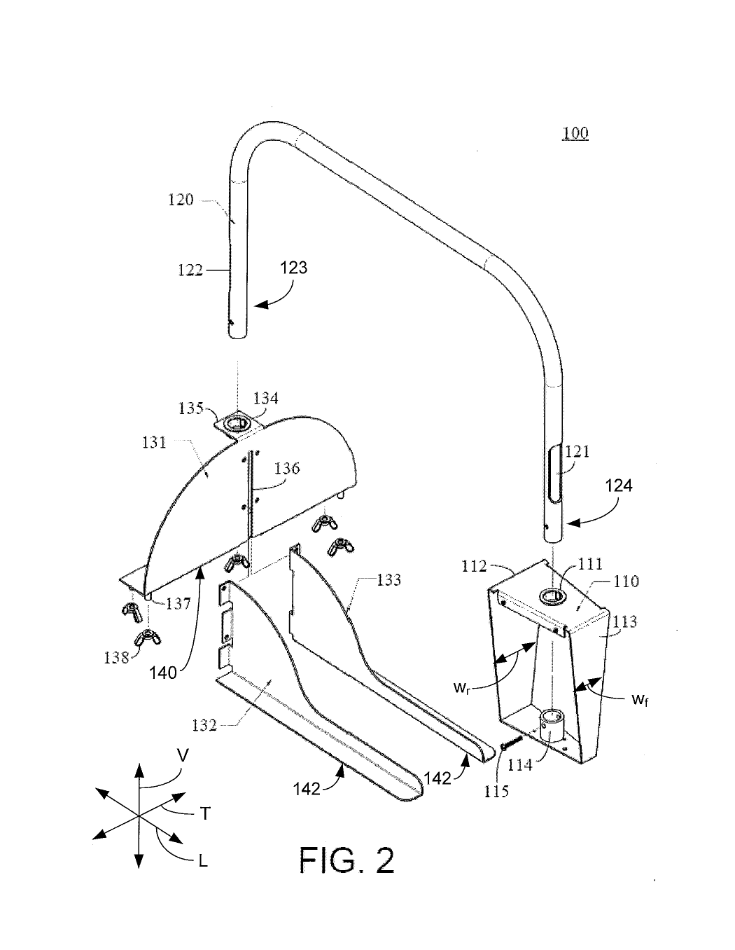

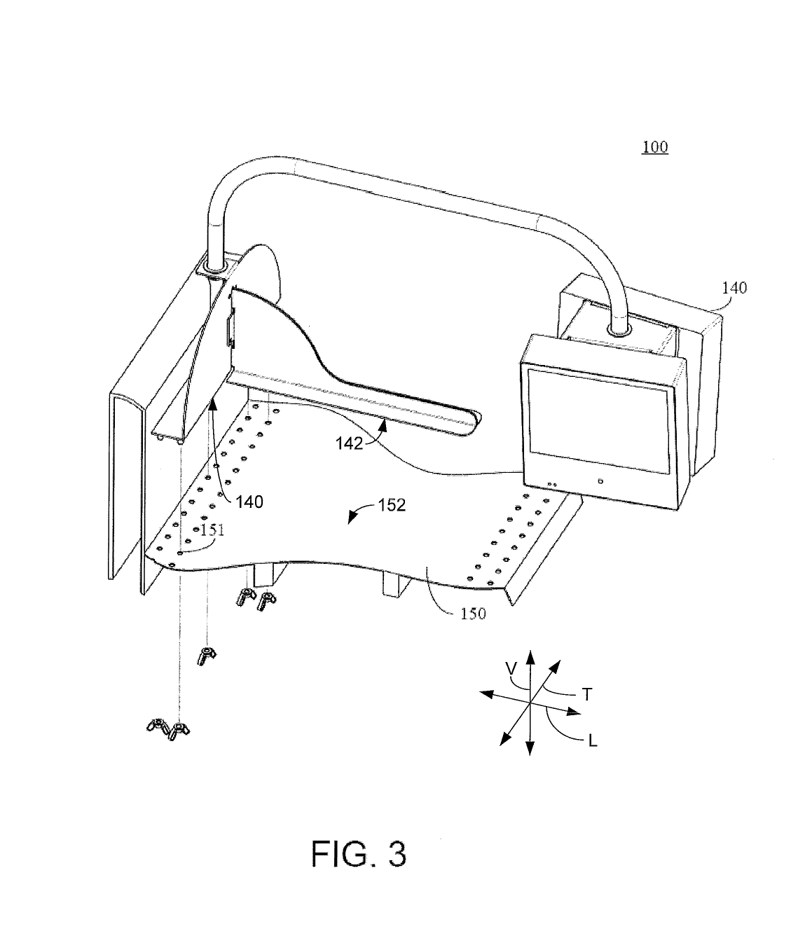

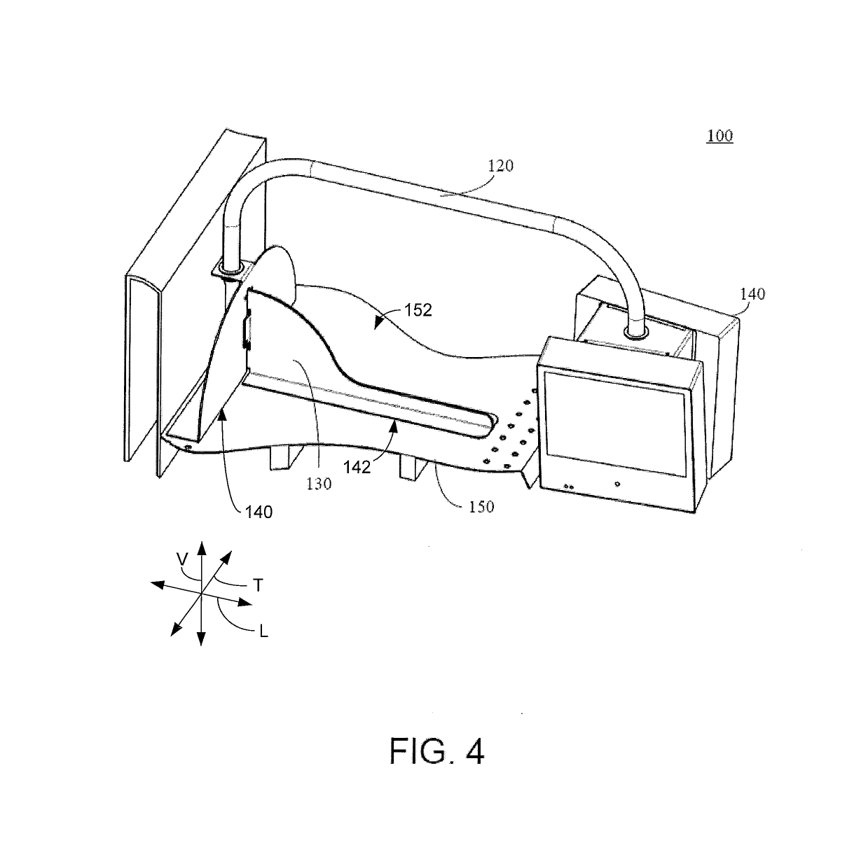

FIGS. 1-4 illustrate a monitoring device mounting system or over-shelf monitoring device mounting system 100 according to an exemplary embodiment of the present disclosure. Specifically, FIG. 1 depicts the mounting system 100, FIG. 2 depicts the mounting system 100 in an exploded view, and FIGS. 3 and 4 depict the mounting system 100 in relation to a pre-existing shelf structure.

Referring to FIGS. 1-4, over-shelf monitoring device mounting system 100 can be provided to mount a monitoring device 140 to a pre-existing structure for premises monitoring such as theft deterrence and/or detection. The mounting system 100 can include a monitoring device housing 110 for supporting monitoring device 140 thereon, a support arm 120 for supporting monitoring device housing 110, and a mounting bracket 130 for mounting support arm 120 to the pre-existing structure. The mounting system 100 defines a vertical direction V, a lateral direction L, and a transverse direction T. The vertical, lateral, and transverse directions V, L, and T are mutually perpendicular and form an orthogonal direction system.

The monitoring device housing 110 can be manufactured from any type of non-deforming material such as plastic, steel or aluminum. The housing 110 can be formed such that the monitoring device 140 is arranged approximately perpendicular to shelf 150 when monitoring device 140 is coupled to the housing 110. For instance, a width w_{f} of a front portion 113 of housing 110 along the transverse direction T can be less than a width wᵣ of a rear portion 112 of housing 110 along the transverse direction T, e.g., such that the monitoring device 140 is approximately ten degrees off of perpendicular. However, the angle and placement of the monitoring device 140 can be modified to fit desired monitoring locations. Bushing 111 can be disposed to surround a hole in the top portion of the housing 110. The bushing 111 can align and guide the support arm 120 into the housing as well as prevent displacement of the support arm 111 after the support arm 120 is coupled to the housing 111 in the tube stop flange 114 using a fastener 115.

Support arm 120 can be coupled between the housing 110 and the bracket 130. In particular, support arm 120 extends between a first end portion 123 and a second end portion 124. First and second end portions 123 and 124 are spaced apart from each other along the lateral direction L and are both oriented in the vertical direction V. Housing 110 is mounted to support arm 120 at second end portion 124 of support arm 120. Support arm 120 is mounted to bracket 130 at first end portion 123 of support arm 120.

Openings 121, 122 can be formed in the support arm 120, e.g., at first and second end portions 123 and 124, respectively. Electrical cords coupled to the monitoring device 140, such as power and/or video cables, can pass through the openings such that the support arm 120 protects and houses the cords. Although shown with a u-shaped configuration, support arm 120 can have any shape or arrangement that allows the monitoring device 140 to be coupled over the shelf 150. For instance, support arm 120 can be a single integral support or a plurality of pieces coupled together. In addition, support arm 120 can be manufactured from a non-deforming material such as plastic, carbon, steel, or aluminum or the length and/or height of support arm 120 can be adjustable.

As discussed above, second end portion 124 of support arm 120 is coupled to housing 111, and first end portion 123 of support arm 120 is coupled to bracket 130. Bracket 130 can include a back brace 131, a left brace 132, and right brace 133. Back brace 131 has a bottom surface 140 and left and right braces 132 and 133 each have a bottom surface 142. Bottom surface 140 of back brace 131 and bottom surfaces 142 of left and right braces 132 and 133 are substantially coplanar, and bottom surface 140 of back brace 131 and bottom surfaces 142 of left and right braces 132 and 133 sit on a top surface 152 of shelf 150 when mounting system 100 mounts monitoring device 140 to shelf 150. Bottom surface 140 of back brace 131 extends along the transverse direction T, and bottom surfaces 142 of left and right braces 132 and 133 extend along the lateral direction L. Thus, bottom surface 140 of back brace 131 and bottom surfaces 142 of left and right braces 132 and 133 are perpendicularly oriented to each other in a plane that is perpendicular to the vertical direction V.

Back brace 131 can include a tab 134 and a bushing 135 disposed in a hole in the tab 134 to guide and support the support arm 120. A tube stop flange (not shown) can be disposed on a rear surface of the back brace 131 to provide a coupling element for support arm 120. When the back brace 131, left brace 132, and right brace 133 are separate elements, a slit 136 can be formed in the back brace 131 where the left and right brace 132 and 133 can be inserted to couple the braces 131, 132, and 133 together. Alternatively, bracket 130 can be formed integrally or left and right brace 132, 133 can be formed integrally (e.g., such that left and right braces 132 and 133 form a front braced 180) and then coupled in a slit form in back brace 131. Projections 137 can extend from a bottom surface 140 of back brace 131 corresponding to pre-exiting holes within the shelf 150. The projections 137 can include threads such that threaded fasteners 138 can be threaded onto the projections 137 to provide a coupling support to the shelf 150 when installed.

The over-shelf monitoring device mounting system 100 can be installed onto a pre-existing structure such as shelf 150 by inserting projections 137 into pre-existing holes 151 formed in the shelf 150. Threaded fasteners 138 can be coupled to the projections 137 after the projections 137 are inserted through the pre-existing holes 151. Left and right brace 132, 133 can extend perpendicularly across shelf 150 to provide support and prevent displacement of the monitoring device mounting system 100. While bracket 130 is shown to be coupled with pre-existing holes 151 on the rear portion of shelf 150, bracket 130 can alternatively or additionally be coupled with pre-existing holes on the front portion of shelf 150.

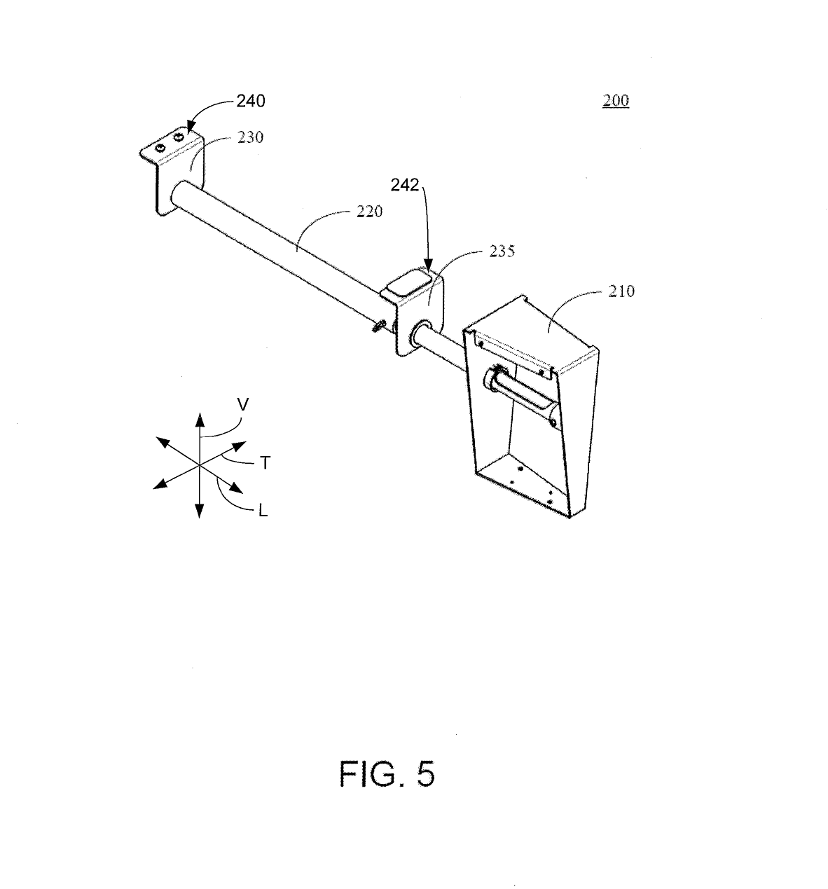

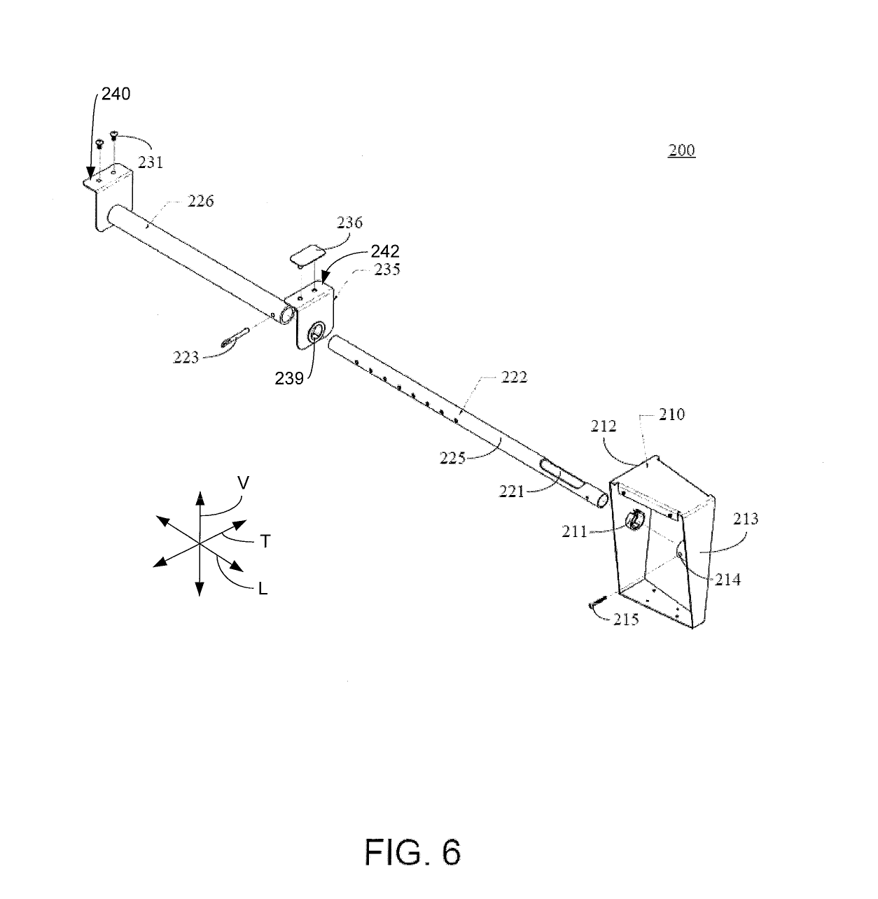

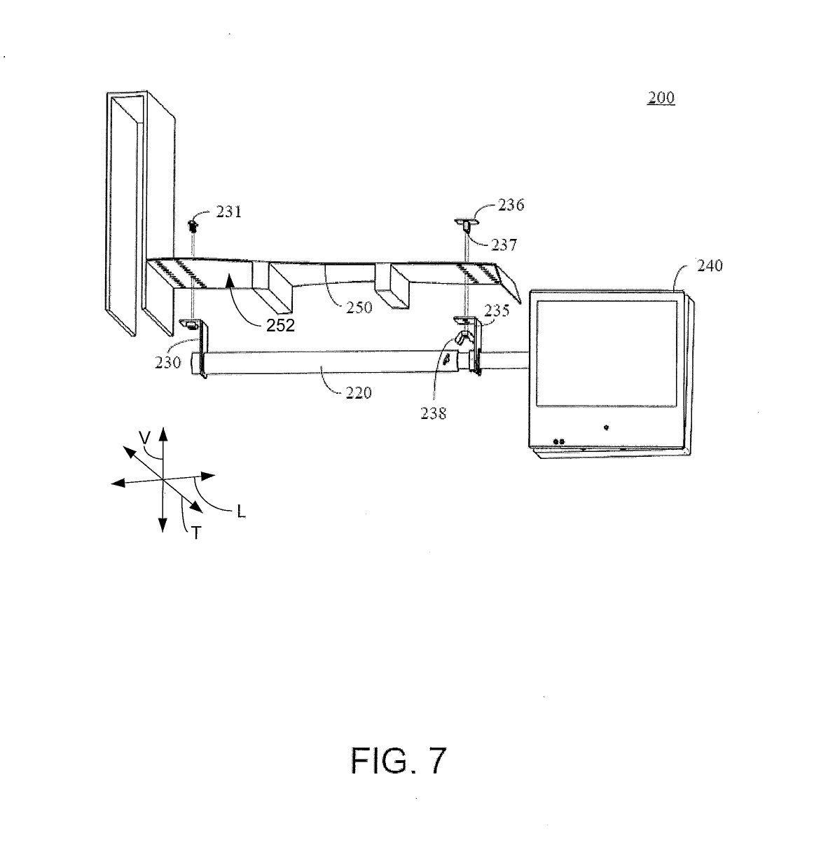

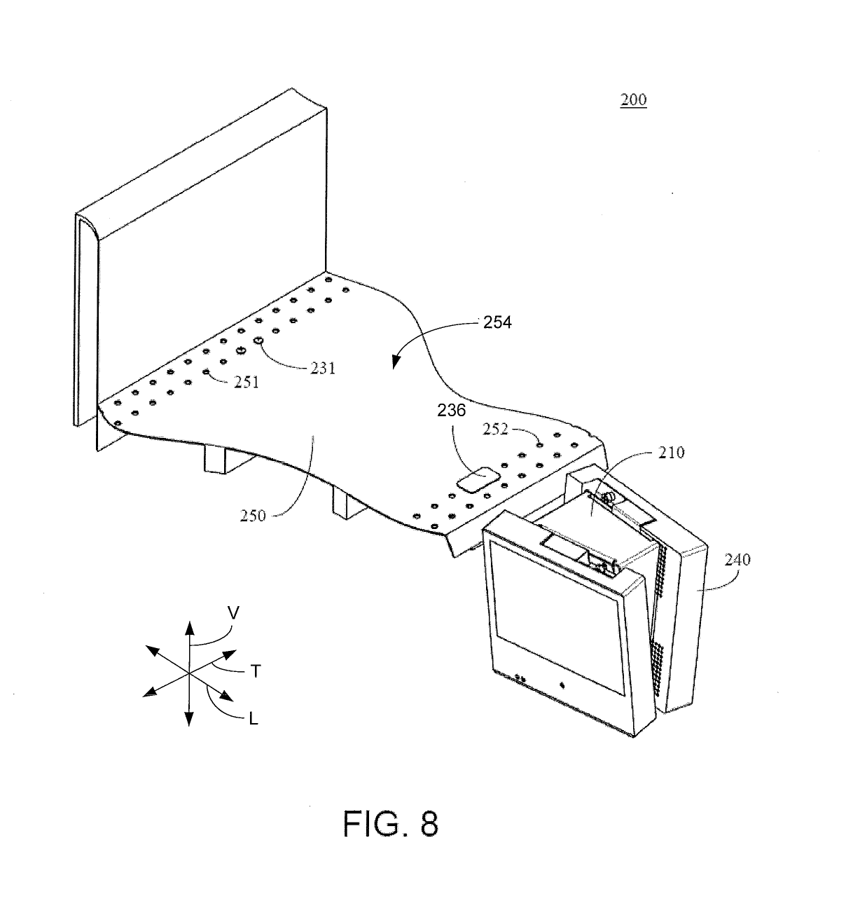

FIGS. 5-8 illustrate a monitoring device mounting system or an under-shelf monitoring device mounting system 200 according to an exemplary embodiment of the present disclosure. Specifically, FIG. 5 depicts the mounting system 200, FIG. 6 depicts the mounting system 200 in an exploded view, and FIGS. 7 and 8 depict the mounting system 200 in relation to a pre-existing shelf structure.

Referring to FIGS. 5-8, under-shelf monitoring device mounting system 200 can include a monitoring device housing 210 for supporting a monitoring device 240 thereon, a support arm 220 for supporting monitoring device housing 210, and mounting brackets 230, 235 for mounting support arm 220 to the pre-existing shelf structure. Housing 210 can be similar in material, shape, and arrangement as housing 110. However, support arm 220 can be coupled to the rear portion 212 of housing 210 such that the support arm 220 passes through bushing 211 and is coupled to a tube stop flange 214 formed on the front portion 213 of housing 210 using a fastener 215.

Support arm 220 can include a first portion 225 and a second portion 226 and can be coupled between housing 210 and bracket 230 and further supported by bracket 235. Housing 210 is mounted to first portion 225 of support arm 220. Opening 221 can be formed in the support arm to provide access for electrical cords coupled to the monitoring device 240. The support arm 220 can be a telescoping support such that the length of the support arm 220 along the lateral direction L is adjustable by inserting pin 223 into a desired hole 222. The first portion 225 of the support arm 220 can have a smaller diameter than the second portion 226 such that the first portion 225 can pass through a bushing 239 in bracket 235 and be inserted into the second portion 226 of the support arm 220. Thus, first portion 225 is slidably received within second portion 226. The second portion 226 of the support arm 220 can be formed integrally with bracket 230 or it can be formed separately and then coupled to bracket 230.

The under-shelf monitoring device mounting system 200 can be coupled to a pre-existing display, such as a shelf 250 using brackets 230 and 235. Brackets 230 and 235 each have a top surface 240 and 242, respectively. Top surfaces 240 and 242 of brackets 230 and 235 rest against a bottom surface 252 of shelf 250 when mounting system 200 mounts monitoring device 240 to shelf 250. Bracket 230 can be coupled through rear pre-existing holes 251 of shelf 250 using threaded fasteners 231, such as screws. Bracket 235 can be coupled to the shelf 250 using a coupling plate 236 that rests on a top surface 254 of shelf 250. Coupling plate 236 can have projections 237 that pass through front pre-existing holes 252 of shelf 250. Projections 237 can include threading such that a fastener 238 can be coupled to the projection to secure the coupling plate 236 to the shelf. The coupling plate 236 can provide support for the mounting system 220 while minimizing interference with products displayed on the shelf 250.

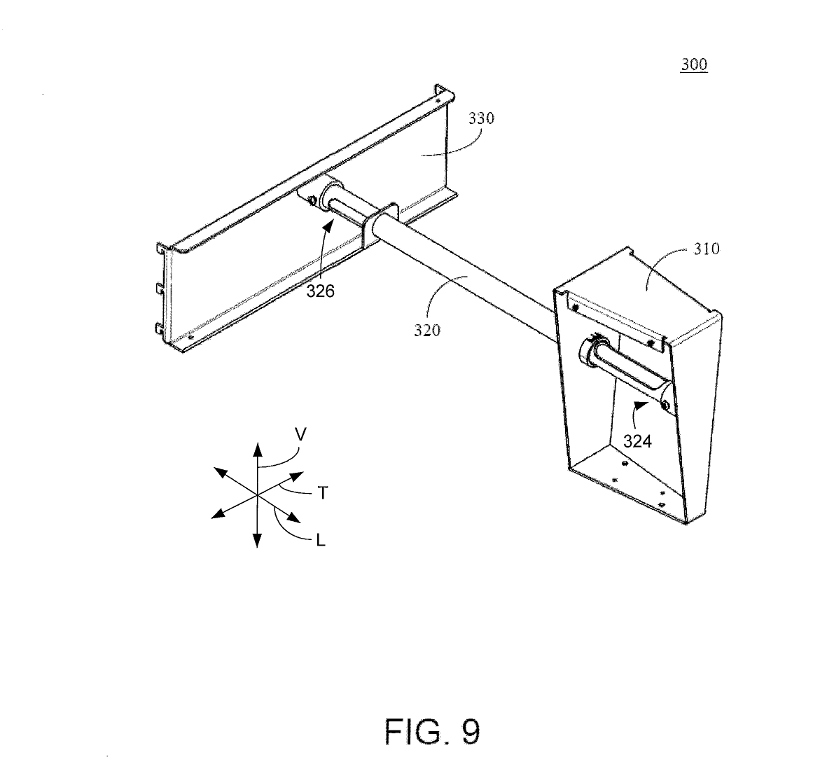

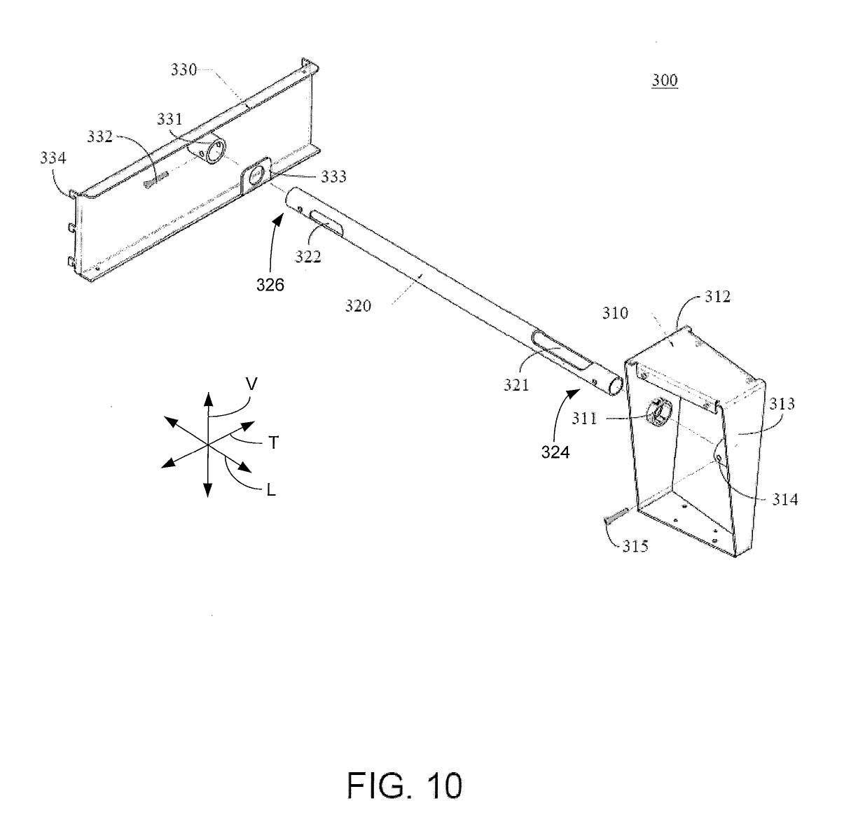

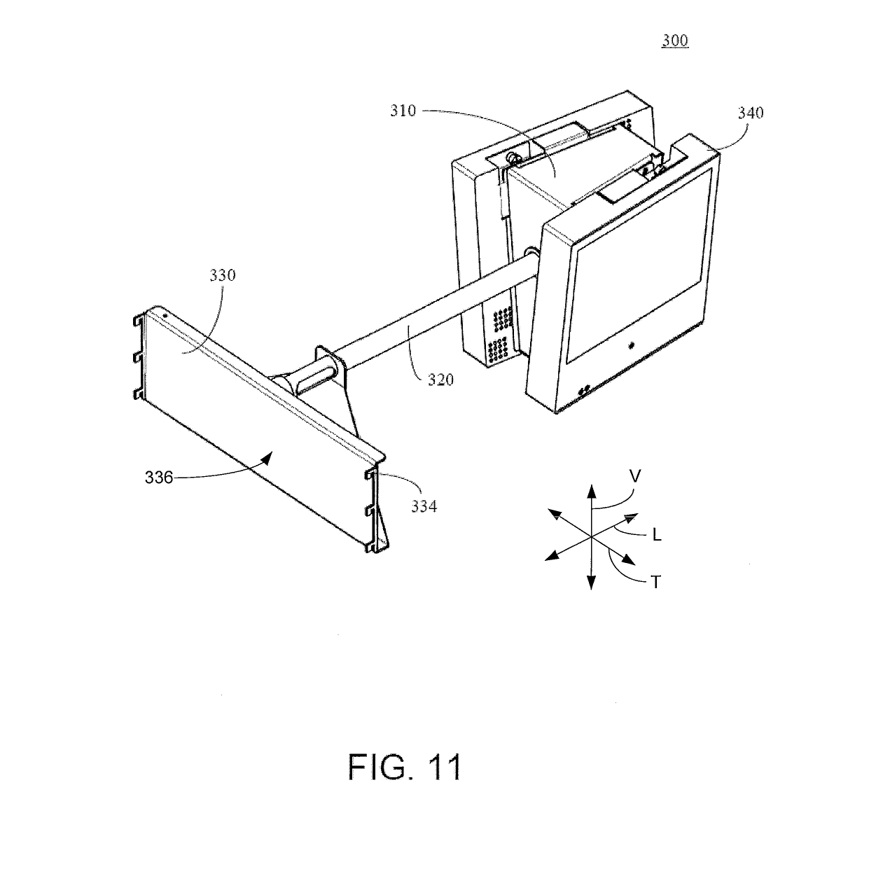

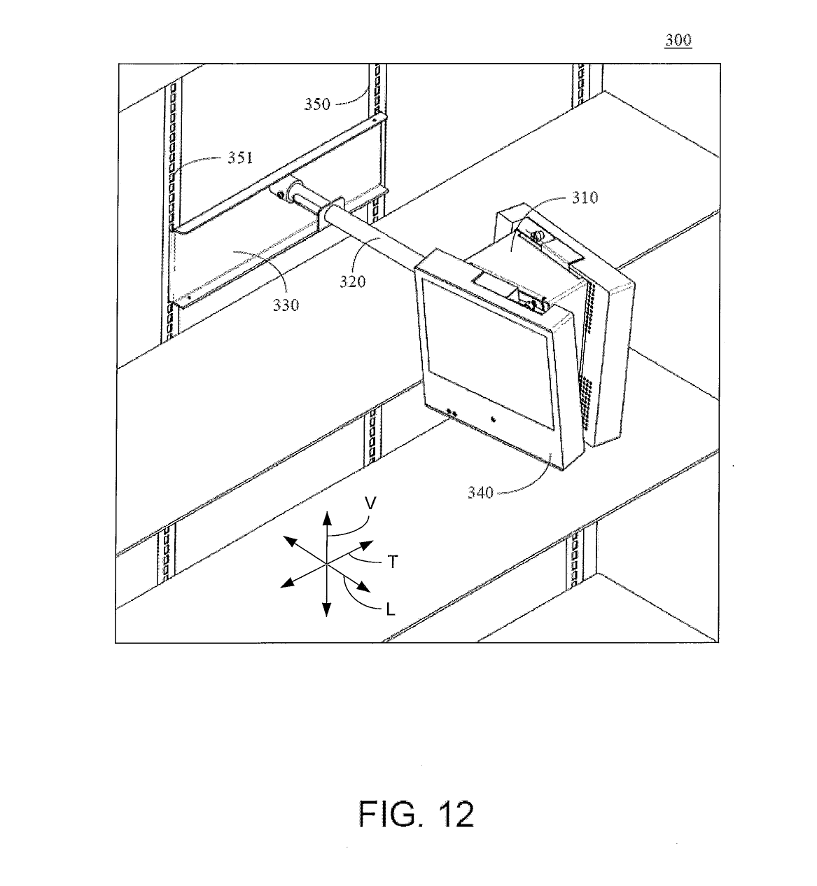

FIGS. 9-12 illustrate a monitoring device mounting system or monitoring device wall mounting system 300 according to an exemplary embodiment of the present disclosure. Specifically, FIG. 9 depicts the mounting system 300, FIG. 10 depicts the mounting system 300 in an exploded view, and FIGS. 11 and 12 depict the mounting system 300 in relation to a pre-existing wall structure.

Referring to FIGS. 9-12, monitoring device wall mounting system 300 can be provided to mount a monitoring device 340 to a pre-existing wall structure for premises monitoring such as thief deterrence and/or detection. The mounting system 300 can include a monitoring device housing 310 for supporting monitoring device 340 thereon, a support arm 320 for supporting monitoring device housing 310, and a wall mounting bracket 330 for mounting support arm 320 to the pre-existing wall structure.

Housing 310 can be similar in material, shape, and arrangement as housing 210. Support arm 320 can be coupled to the rear portion 312 of housing 310 such that the support arm 320 passes through bushing 311 and is coupled to a tube stop flange 314 formed on the front portion 313 of housing 310 using a fastener 315.

Support arm 320 extends between a first end portion 324 and a second end portions 326. The first and second end portions 324 and 326 of support arm 320 are spaced apart from each other, e.g., along the lateral direction L. Housing 310 is mounted to support arm 320 at first end portion 324 of support arm 320, and support arm 320 is mounted to wall mounting bracket 330 at second end portion 326 of support arm 320.

Openings 321, 322 can be formed in support arm 320, e.g., at first and second end portions 324 and 326, respectively, to provide housing for electrical cords coupled to the monitoring device 340. Support arm 320 can be an integral structure. Alternatively, support art 320 can include a plurality of section and/or have telescoping capabilities to adjust the length of support, e.g., along the lateral direction L.

Wall bracket 330 can be a formed in any shape, size, or configuration such that a plurality of projections 334 can correspond to openings 351 in a wall support 350. Projections 334 can be formed on the outer portions of the wall bracket 330. Alternatively, projections 334 can be formed anywhere on a rear surface 336 of the wall bracket 330 to provide stability during mounting. The support arm 320 can pass through a tab 333 and be coupled to a tube stop flange 331 formed in the wall bracket 330 using a fastener 332. Tab 333 and tube stop flange 331 are spaced apart from each other along the lateral direction L.

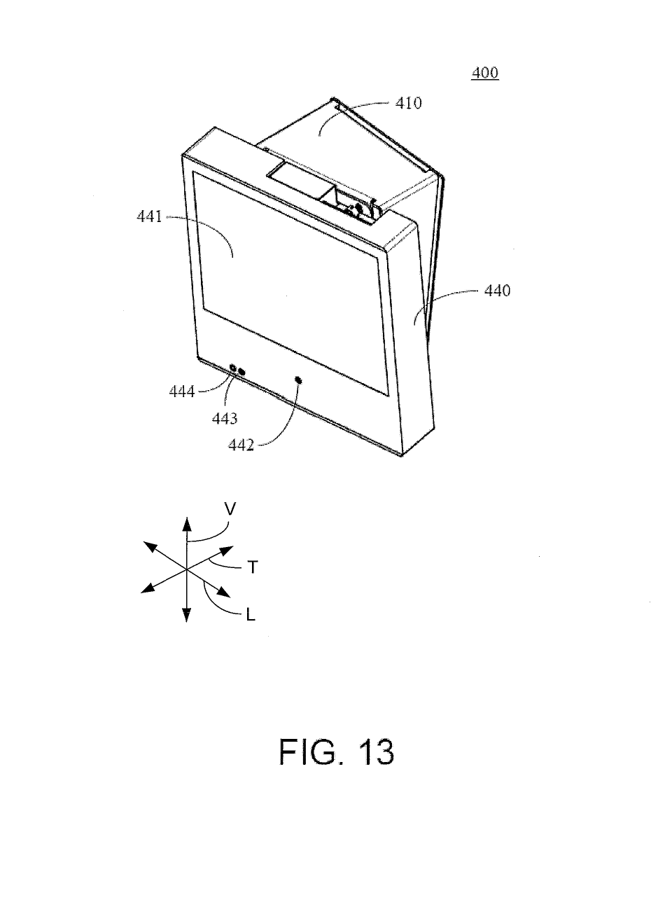

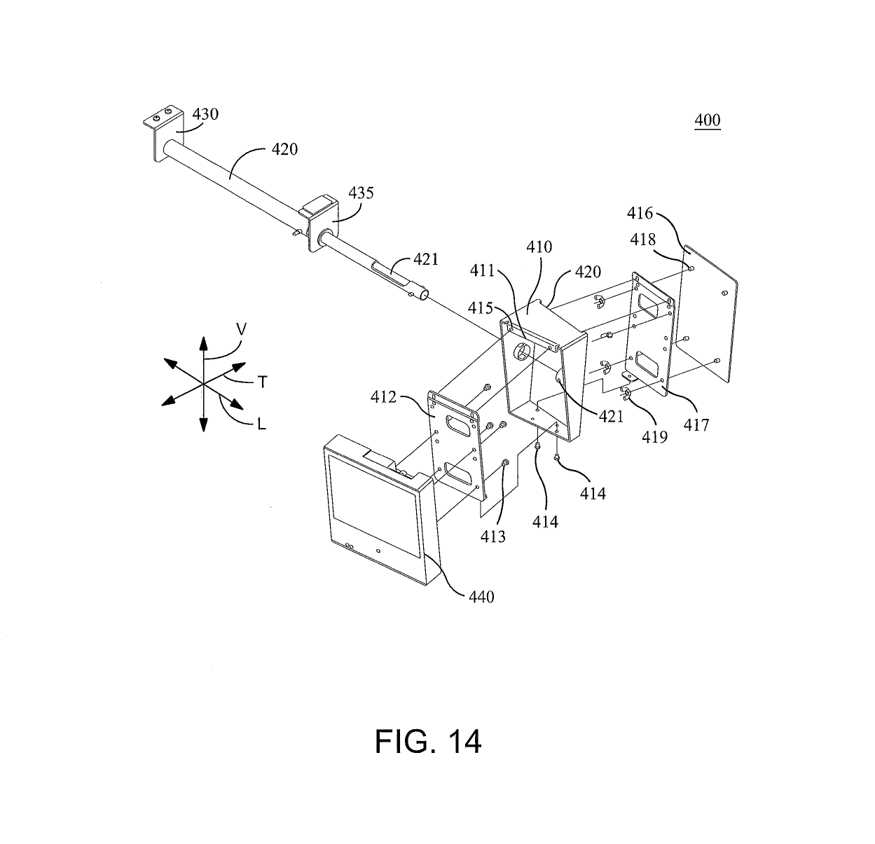

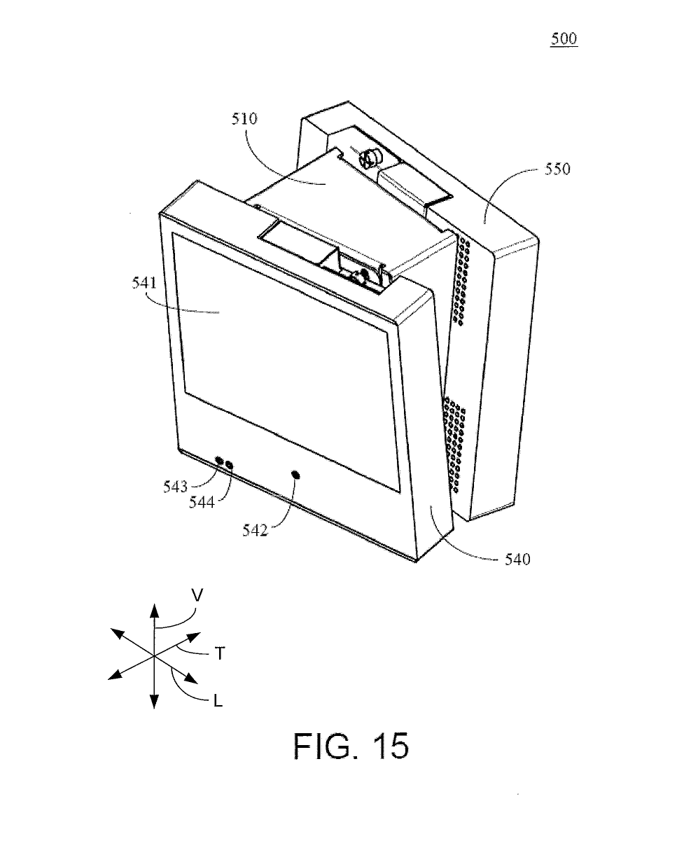

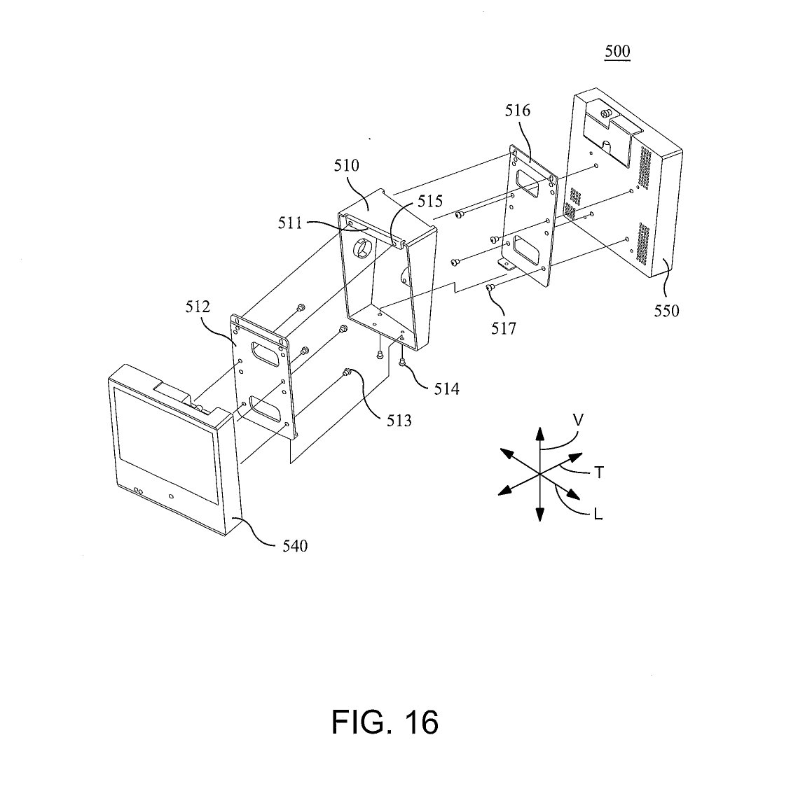

FIGS. 13-16 illustrate monitoring device mounting systems or display mounting systems 400 and 500 according to exemplary embodiments of the present disclosure. Specifically, FIG. 13 depicts a single display mounting system 400, FIG. 14 depicts an exploded view of the singe display mounting system 400, FIG. 15 depicts a dual display mounting system 500, and FIG. 16 depicts an exploded view of the dual display mounting system 500.

Referring to FIGS. 13-14, single display mounting system 400 can include a monitoring device 440, a monitoring device housing 410 for supporting the monitoring device 440 thereon, a support arm 420 for supporting monitoring device housing 410, and a bracket 430 for mounting support arm 420, e.g., to a display. Monitoring device 440 can include a display 441, a camera 442, an input device 443, and a motion sensor 444. Display 441 can be any size suitable for mounting on a pre-existing structure and any type of display. For instance, display 441 can be an 8 inch liquid crystal display. Camera 442 can be a wide angle lens camera. A user can select various options or settings for the monitoring device using input device 443. Motion sensor 444 can detect when a customer approaches the monitoring device.

The camera 442 of the monitoring device 440 can constantly monitor the area within the line of sight of the camera. Alternatively, the motion sensor 444 can detect when a customer enters within a predetermined range of the monitoring device. This can activate the camera 442 and provide a corresponding image on the display 441. The image provided on the display 441 can be recorded at the monitoring device, at a remote location, or it merely be displayed and not recorded.

The monitoring device 440 can be mounted to housing 410 using a mounting plate 412. The mounting plate 412 can be coupled to the monitoring device 440 using fasteners 413, such as screws. The mounting plate 412 can then be mounted to housing 410 by sliding into protrusions 415 on a top portion 411 of the housing. Fasteners 414 can then be coupled to a tab (not shown) formed on a lower surface of the mounting plate 412. On the other side of housing 410, a cover plate 416 can be coupled to a rear mounting plate 416. For instance, cover plate 416 can include threaded protrusions 418 and fasteners 419 can couple the rear mounting plate 417 to the cover plate 416. The rear mounting plate 417 and cover plate 416 can be mounted to the rear side 420 of housing 410 in a manner similar to mounting plate 412.

When installing the display mounting system 400 to a pre-existing structure such as a shelf in a retail display, mounting bracket 430 can be coupled to the shelf first. Then support arm 420 can be installed and coupled to the mounting bracket 430 and the tube stop flange 421 in the housing 410. The monitoring device 440 can be mounted to the mounting plate 412 and cords coupled to the monitoring device 440 can be threaded through opening 421. Finally, the monitoring device 440 and the cover plate 416 can be coupled to the housing 410. The display mounting system 400 can be installed at various heights and angles to maximize viewing angles. For instance, the mounting system 440 can be mounted to monitor items on the shelf in order to detect the customers' interaction with the items on the shelf and/or deter a customer from improperly taking items on the shelf.

Referring to FIGS. 15-16, duel display mounting system 500 can include a first monitoring device 540 and a second monitoring device 550 coupled to a housing 510. Each monitoring device can include a display 541, a camera 542, an input device 543, and a motion sensor 544.

The first monitoring device 540 can be mounted to housing 510 using a first mounting plate 512. The mounting plate 512 can be coupled to the monitoring device 540 using fasteners 513, such as screws. The mounting plate 512 can then be mounted to housing 510 by sliding into protrusions 515 on a top portion 511 of the housing. Then fasteners 514 can be coupled to a tab (not shown) formed on a lower surface of the mounting plate 512. On the other side of housing 410, the second monitoring device 550 can be mounted housing 510 similarly the first monitoring device 540 using a second mounting plate 516 and fasteners 517.

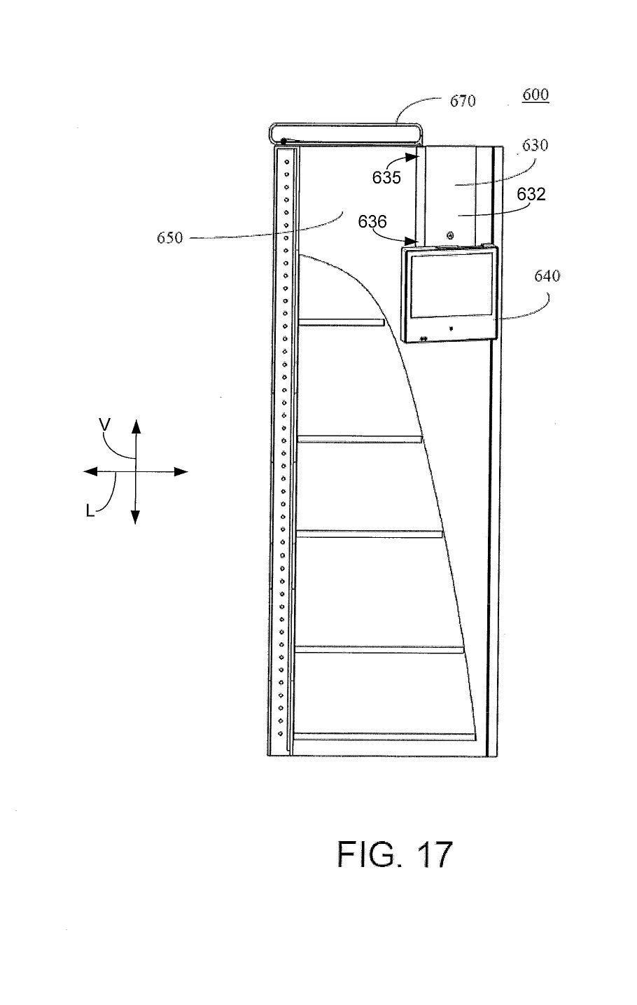

FIGS. 17-18 illustrate a monitoring device mounting system or an over-wall mounting system 600 according to an exemplary embodiment of the present disclosure. Mounting system 600 can include a monitoring device 640, a housing 610 for supporting monitoring device 640 thereon, and an over-wall mounting bracket 630 for mounting housing 610, e.g., to a display. The mounting bracket 630 and the monitoring device 640 can be coupled to housing 610 where the mounting bracket 630 extends over the wall 650 of the display.

Mounting bracket 630 has a front plate 632 and a top plate 634. Top plate 634 and front plate 632 are perpendicularly oriented to each other in a plane that is perpendicular to the lateral direction L. Top plate 634 extends along the transverse direction T and is configured for resting on a top surface 652 of the wall 650. Housing 610 is mounted to mounting bracket 630 at front plate 632 of mounting bracket 630. Front plate 632 extends along the vertical direction V between a top portion 635 and a bottom portion 636. Housing 610 is positioned adjacent bottom portion 636 of front plate 632, and top plate 634 is mounted to front plate 632 at top portion 635 of front plate 632.

A cord housing 670 extends along the vertical direction V along wall 650. Cord housing 670 can be integral or coupled with mounting bracket 630 to house and protect cord 671 coupled to the monitoring device 640.

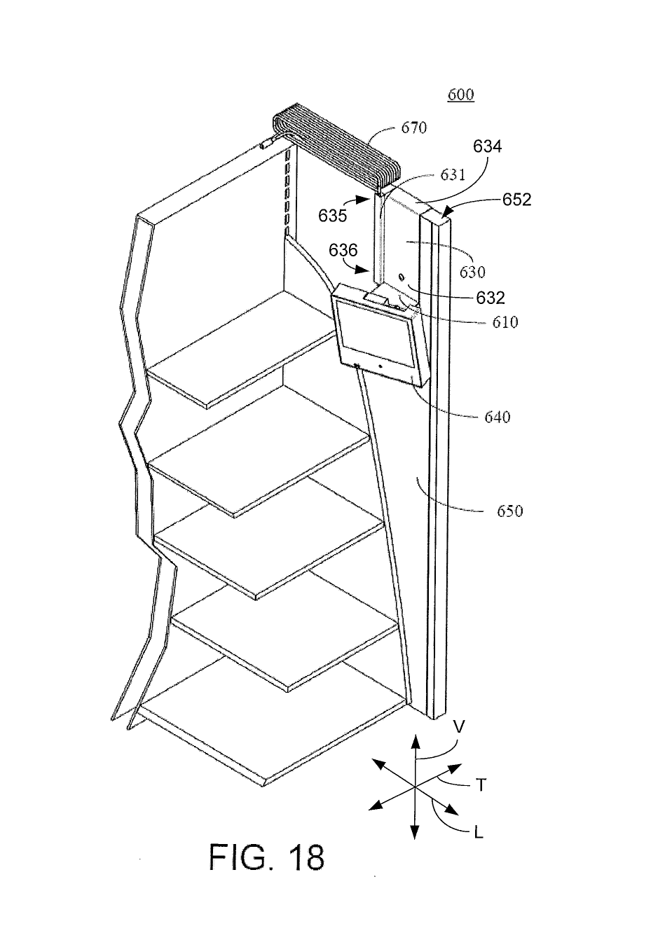

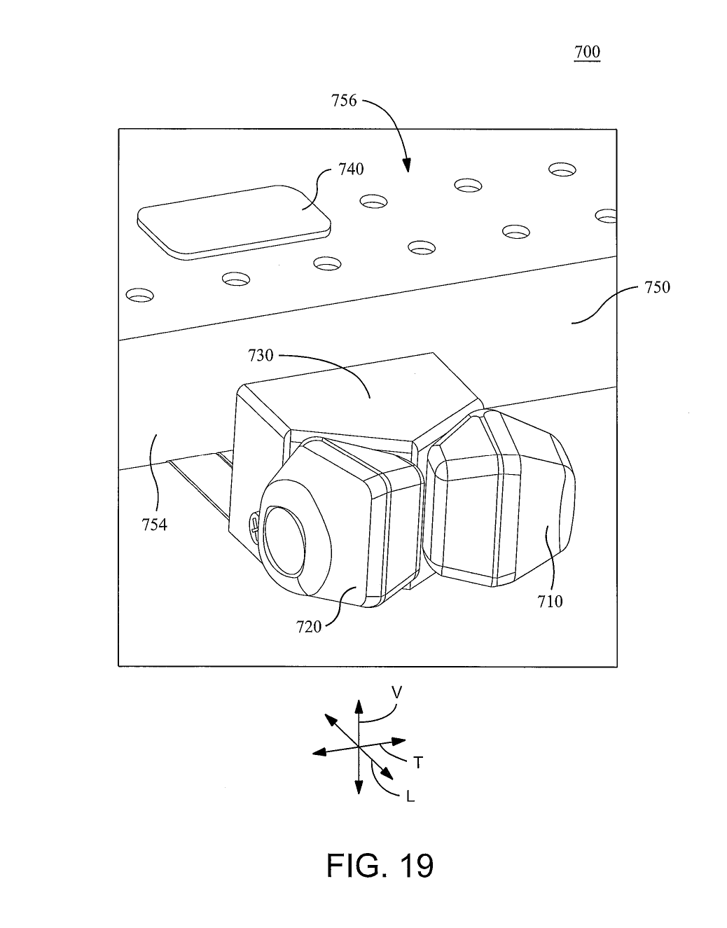

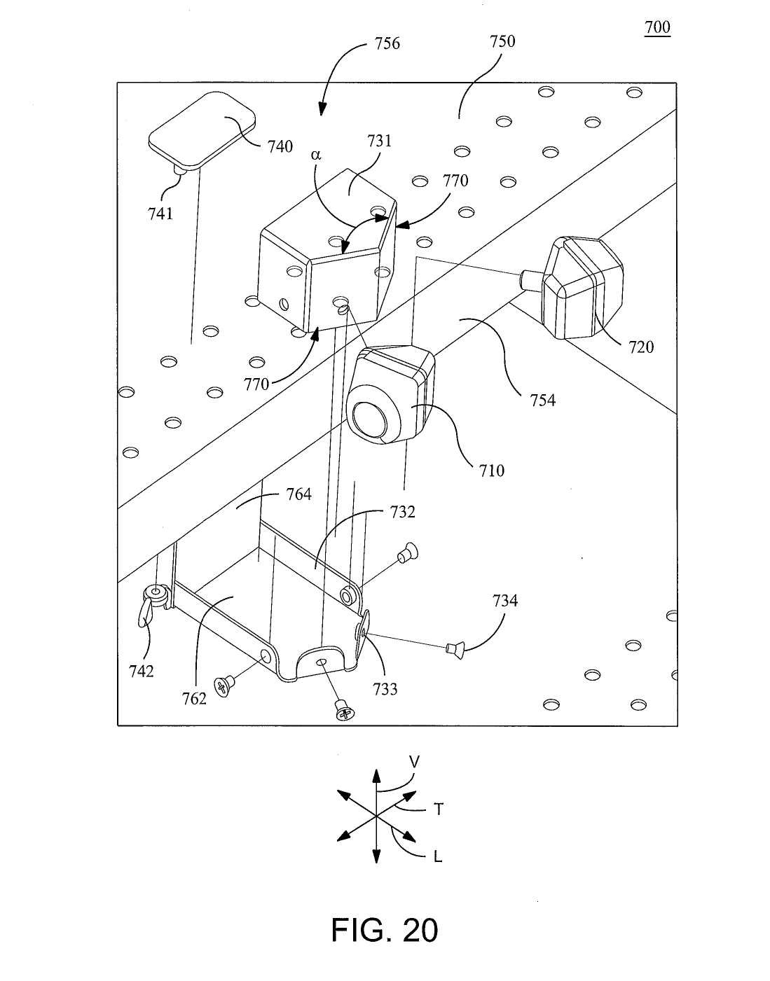

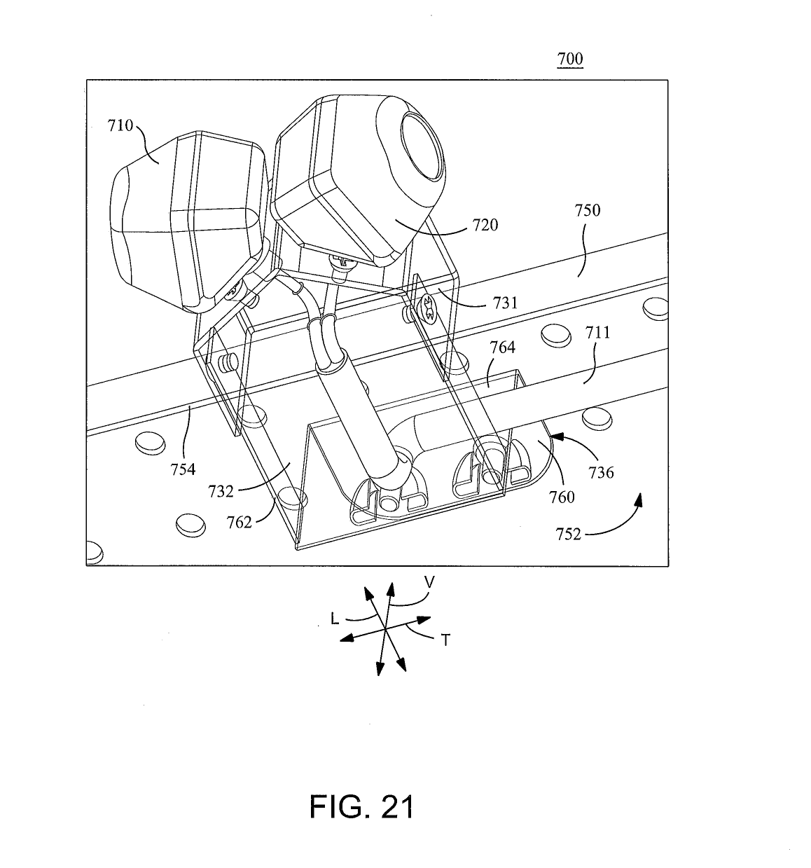

FIGS. 19-21 illustrate a monitoring device mounting system or an angled front shelf monitoring mounting system 700 according to an exemplary embodiment of the present disclosure. Specifically, FIG. 19 depicts a perspective view of the mounting system 700, FIG. 20 depicts an exploded view of the mounting system 700, and FIG. 21 depicts an alternative perspective view of the mounting system 700.

Referring to FIGS. 19-21, angled front shelf monitoring mounting system 700 can be mounted to a pre-existing retail display element without modification such as a shelf, a clothes rack, a checkout stand, or a jewelry rack for premises monitoring such as theft deterrence and/or detection using standard tools such as a screwdriver. Mounting system 700 can include a first camera 710 and a second camera 720 coupled to a bracket 730 and mounted to a pre-existing element such as a shelf 750 using a coupling plate 740.

Bracket 730 can include a monitoring device housing or camera mounting portion 731 and a mounting bracket or shelf mounting portion 732. Shelf mounting portion 732 includes a top surface 736 configured for resting on a bottom surface 752 of shelf 750. Top surface 736 of shelf mounting portion 732 and s camera mounting portion 731 of bracket 730 are spaced apart from each other along, e.g., the lateral direction L. In particular, a lip 754 of shelf 750 can be disposed between top surface 736 of shelf mounting portion 732 and camera mounting portion 731 of bracket 730 along the lateral direction L. Shelf mounting portion 732 includes a top plate 760 that defines top surface 736 of shelf mounting portion 732, a bottom plate 762 spaced apart from top plate 760 along the vertical direction V, and a side plate 764 that extends between and connects top plate 760 and bottom plate 762 along the vertical direction V. Top and bottom plates 760 and 762 are also spaced apart from each other along the lateral direction L.

Each portion of bracket 730 can be fabricated from a non-deforming material, such as sheet metal. Tabs 733 can be formed in the shelf mounting portion 732 of bracket 730 and fasteners 734 can be used to couple the camera mounting portion 731 of bracket 730 with the shelf mounting portion 732. The shelf mounting portion 732 can be formed such that electrical cords 711 such as power and/or video cables can be coupled to cameras 710 and 720 in an unobtrusive way. For instance, the electrical cords 711 can lie along the inside of lip 754 of the shelf 750. Alternatively, bracket 730 can be formed integrally to form a single element.

Cameras 710 and 720 can be any type of camera such as a high resolution analog camera. The cameras 710 and 720 can be arranged such that they are unobtrusive, do not interfere with merchandise displayed on the shelf 750, and effective to act as a deterrent. The cameras 710 and 720 can be arranged on the bracket 730 such that the front portion of bracket 730 is angled away from the shelf 750. While two cameras are illustrated, alternatively a single camera can be coupled to mount bracket 730.

Camera mounting portion 731 of bracket 730 defines a pair of mounting surfaces 770. Cameras 710 and 720 are mounted to a respective one of mounting surfaces 770. Mounting surfaces 770 define an angle α in a plane that is perpendicular to the vertical direction V. Angle α may be any suitable angle. For example, angle α may be between about forty degrees and about eighty degrees or about sixty degrees.

Coupling plate 740 can sit on a top surface 756 of shelf and be used to mount bracket 730 to shelf 750. The coupling plate 740 can include protrusions 741, such as threaded studs. Fasteners 742 can be coupled to the protrusions 741 to secure bracket 730 to the shelf 750.

Any images captured by cameras 710 and 720 can be recorded at a remote location, or they can merely be displayed on a display coupled to the cameras 710 and 720 and not recorded. The monitoring mounting system 700 can also include at least one motion sensor to activate cameras 710 and 720.

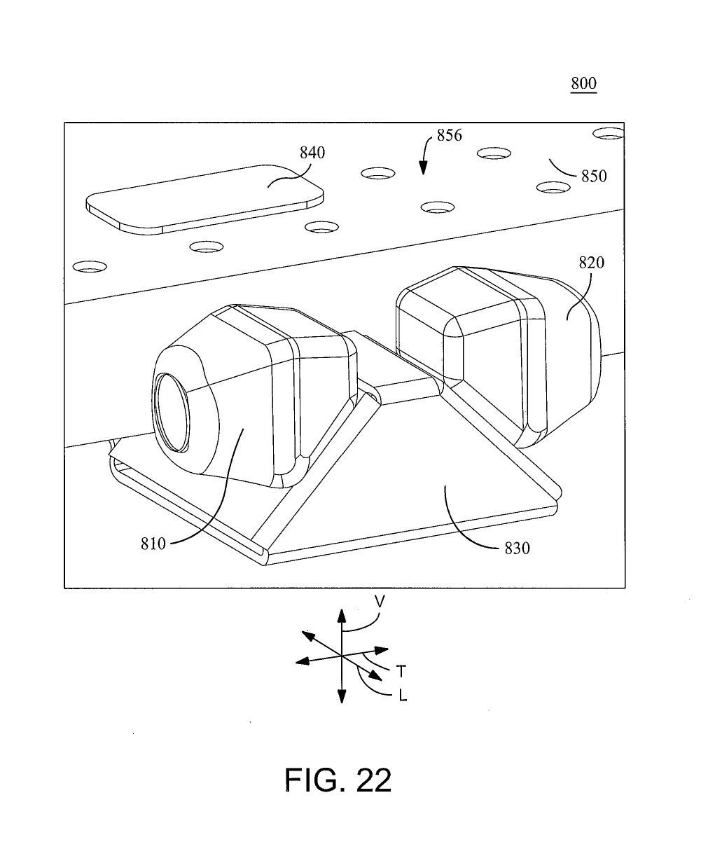

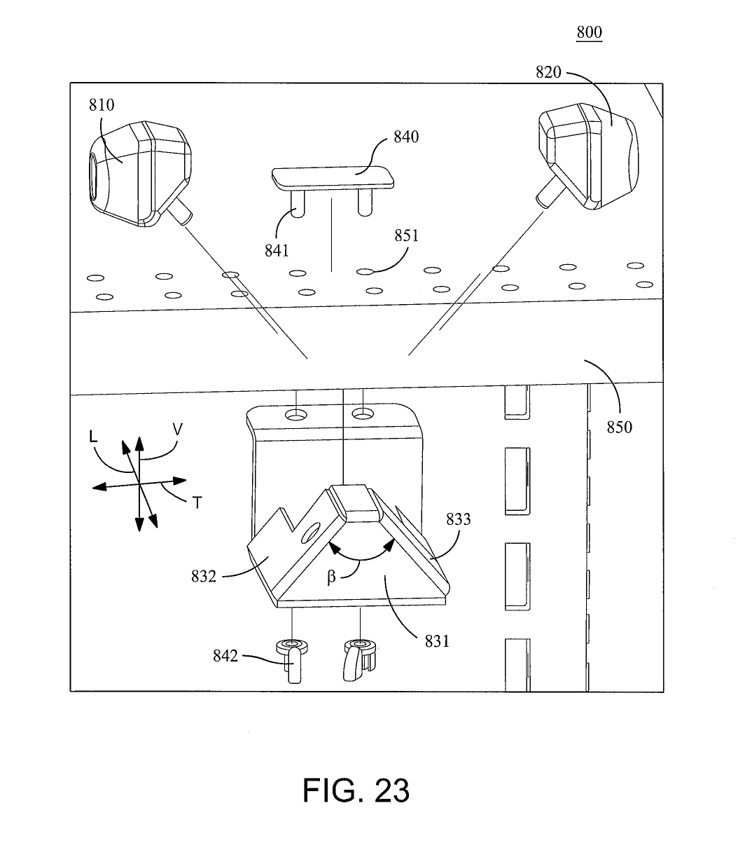

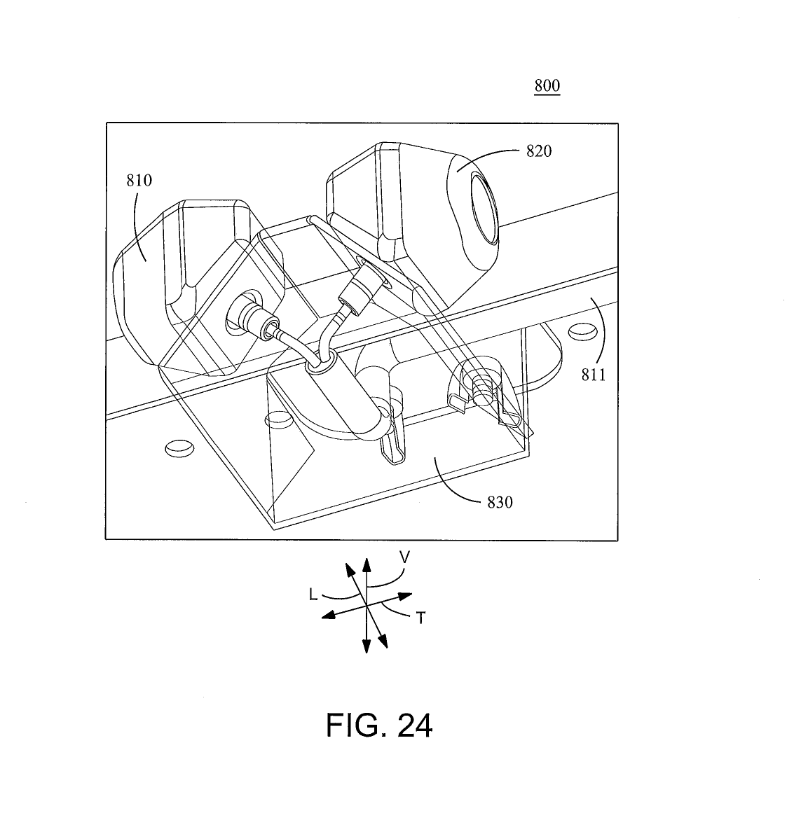

FIGS. 22-24 illustrate a monitoring device mounting system or a parallel front shelf monitoring mounting system 800 according to an exemplary embodiment of the present disclosure. Specifically, FIG. 22 depicts a perspective view of the mounting system 800, FIG. 23 depicts an exploded view of the mounting system 800, and FIG. 24 depicts an alternative perspective view of the mounting system 800.

Referring to FIGS. 22-24, parallel front shelf monitoring mounting system 800 can be mounted to a pre-existing retail display element for premises monitoring such as theft deterrence and/or detection using basic tools. Mounting system 800 can include a first camera 810 and a second camera 820 coupled to a bracket 830 and mounted to a pre-existing element such as a shelf 850 using a coupling plate 740.

Bracket 830 can be formed as a single element or separate elements can be coupled together. The configuration of bracket 830 can have an outer surface 831 that is parallel to the shelf 850. Cameras 810 and 820 can each be mounted onto a monitoring device housing or angled camera mounting portion 832, 833 of the bracket 830 such that the cameras are positioned to adequately monitor the environment around the mounting system 800. The cameras 810 and 820 can be any type of camera and while two cameras are illustrated, any number of cameras can be used to monitor the surrounding environment. For instance, a single camera can be used or an additional camera can be included to monitor the environment perpendicular to the shelf 850.

Camera mounting portions 832 and 833 define an angle β in a plane that is perpendicular to the lateral direction L. Angle β may be any suitable angle. For example, angle α may be between about forty degrees and about eighty degrees or about sixty degrees.

Coupling plate 840 can sit on a top surface 856 of shelf 850 and be used to mount bracket 830 to shelf 850. The coupling plate 840 can have any shape or arrangement such that pre-existing elements of a support, such as holes 851 formed in shelf 850 can be used in installing the mounting system 800. Protrusions 841 of the coupling plate 840 can be coupled with fasteners 842 to secure the bracket 840 to the shelf 850.

The bracket 830 can be formed such that electrical cords 811 such as power and/or video cables can be coupled to cameras 810 and 820 in an unobtrusive way, as illustrated in FIG. 24. For instance, the electrical cords 811 can lay along the inside lip of the shelf 850.

In addition, mounting system 800 can be used any various configurations. For instance, a single mounting system 800 can be coupled to a shelf in an aisle on the premises, multiple mounting systems 800 can be coupled together on the same shelf or different shelves in the same aisle, and/or at least one mounting system 800 can be used in conjunction with a display monitoring system.

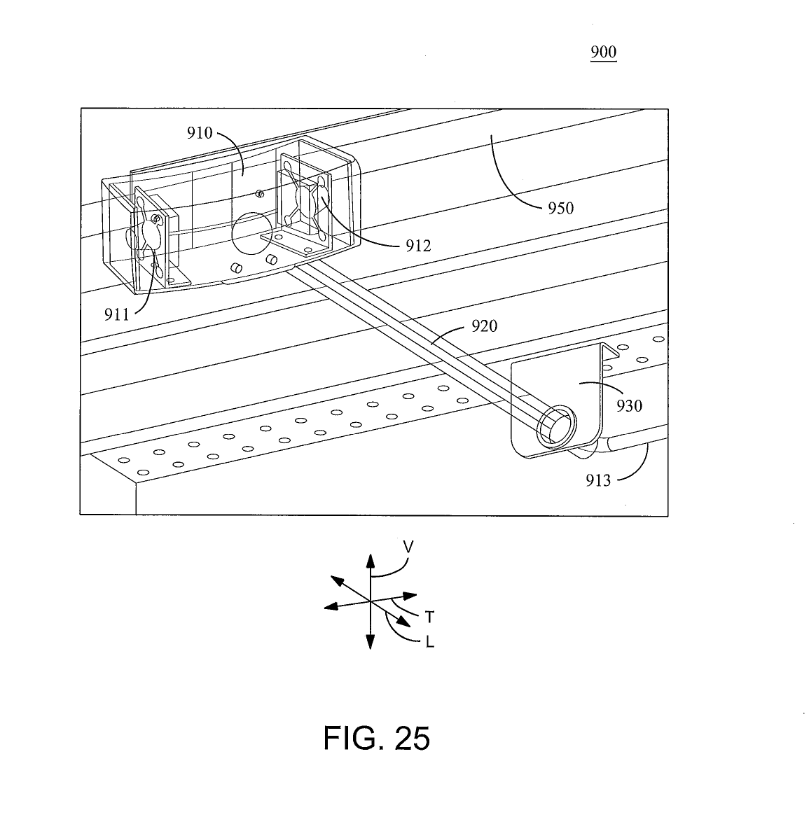

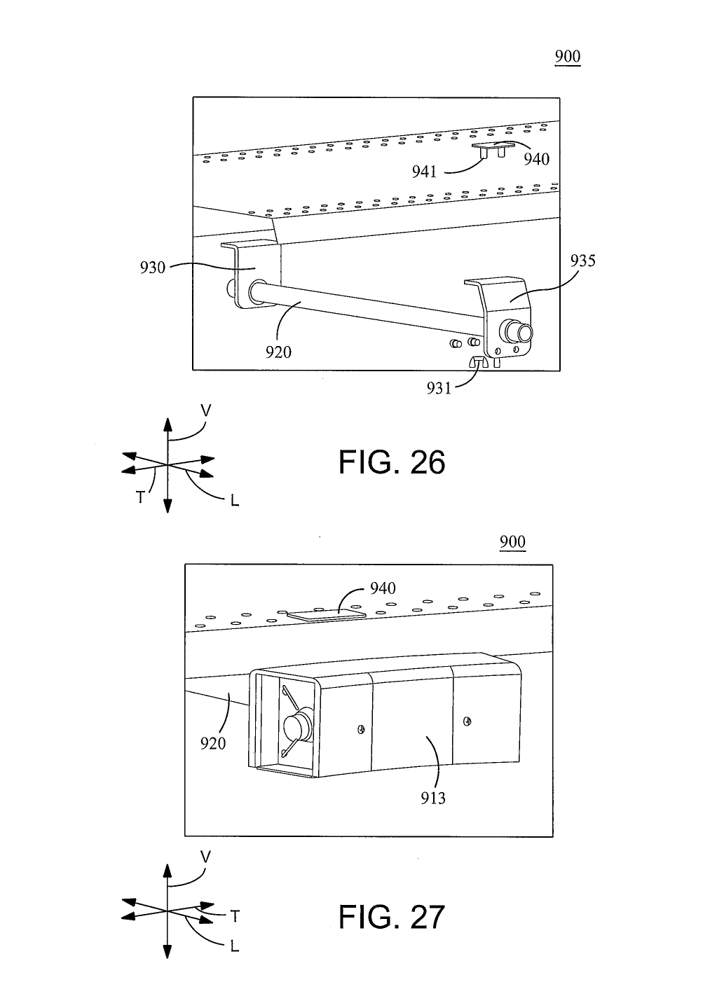

FIGS. 25-27 illustrate a monitoring device mounting system or under shelf monitoring mounting system 900 according to an exemplary embodiment of the present disclosure. Specifically, FIG. 25 depicts a perspective view of the mounting system 900, FIG. 26 depicts an exploded view of a support arm 920 of the mounting system 900, and FIG. 27 depicts an alternative perspective view of the mounting system 900.

Referring to FIGS. 25-27, under shelf monitoring mounting system 900 can be mounted to a pre-existing retail display element such as a shelf 950. Mounting system 900 can include a camera arrangement 910 coupled to a support arm 920 and mounting to a pre-existing display element such as a shelf 950 using brackets 930 and 935 and a coupling plate 940.

Camera arrangement 910 can include one or more cameras 911, 912 within a monitoring device housing 913. The camera arrangement 910 can include any type of cameras such as a high resolution analog camera. Each camera 911, 912 can be angled within the housing 913 such that each can monitor and detect the environment surrounding the mounting system 900.

The camera arrangement 910 can be coupled to a support arm 920. The support arm 920 can be an integral element or include a plurality of pieces coupled together to form the support arm 920. In addition, the support arm 920 can be adjustable to a desired length. Support arm 920 can be coupled to shelf 950 using brackets 930 and 935. Fasteners 931 can be used to couple bracket 930 to shelf 950 though pre-existing holes 951 formed in the shelf. A coupling plate 940 having a plurality of projections 941 can secure bracket 935 to the shelf 950 using fasteners 942. Cords 913, such as power and/or video cords, coupled to the camera arrangement 910 can be threaded through support arm 920.

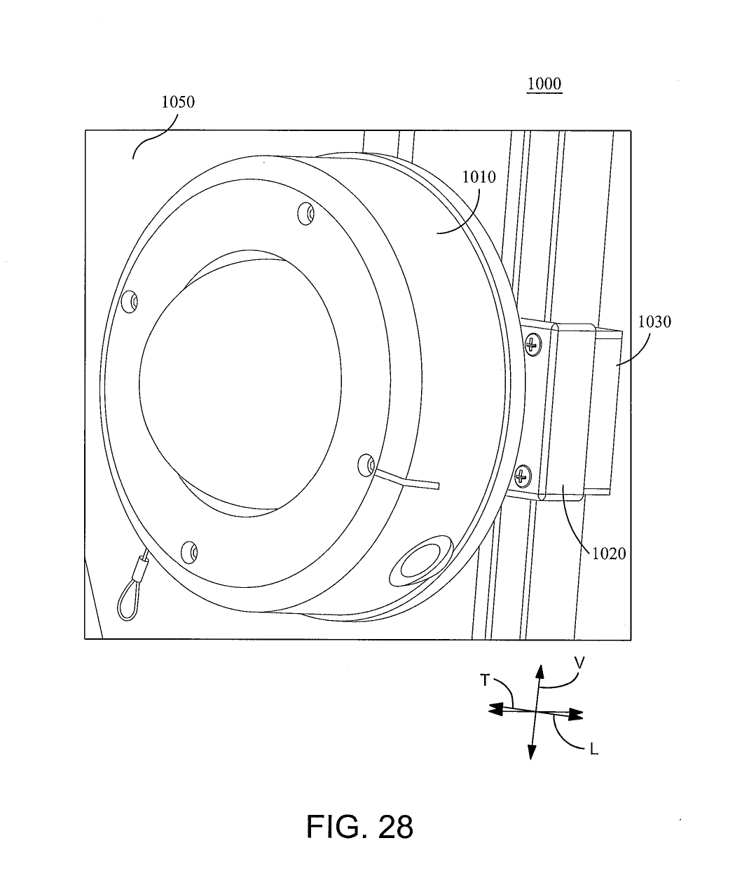

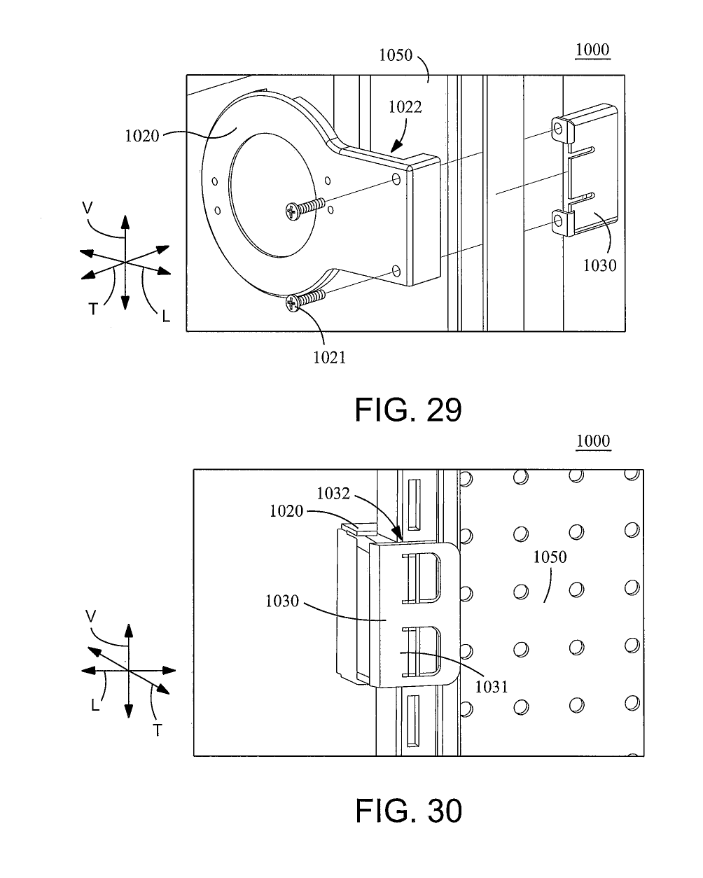

FIGS. 28-30 illustrate a monitoring device mounting system or wall-mounted monitoring system 1000 according to an exemplary embodiment of the present disclosure. Specifically, FIG. 28 depicts a front perspective view of the mounting system 1000, FIG. 29 depicts an exploded view of brackets 1020 and 1030 of the mounting system 1000, and FIG. 30 depicts rear perspective view of the mounting system 1000.

Referring to FIGS. 28-30, a wall mounted monitoring system 1000 can be mounted to a pre-existing retail display wall 1050 without modification for premises monitoring such as theft deterrence and/or detection using basic tools, such as a screwdriver. Mounting system 1000 can include a camera arrangement 1010, a front bracket 1020, and a rear bracket 1030.

Camera arrangement 1010 can be any kind of camera arrangement such as a surface-mounted dome. The camera arrangement 1010 can be coupled to the front bracket 1020 where the front bracket 1020 traverses a portion of the front of the wall 1050 and wraps around a portion of the side of the wall 1050. Thus, a rear surface 1022 of front bracket 1020 and a rear surface 1032 of rear bracket 1030 can rest on wall 1050. Rear surfaces 1022 and 1032 of front and rear brackets 1020 and 1030, respectively, are spaced apart along the transverse direction T and are substantially parallel. Rear bracket 1030 can be coupled to the front bracket 1020 using fasteners 1021. In addition, rear bracket 1030 can include tabs 1031 that are coupled to a pre-existing structure of the wall to provide support for the monitoring system 1000.

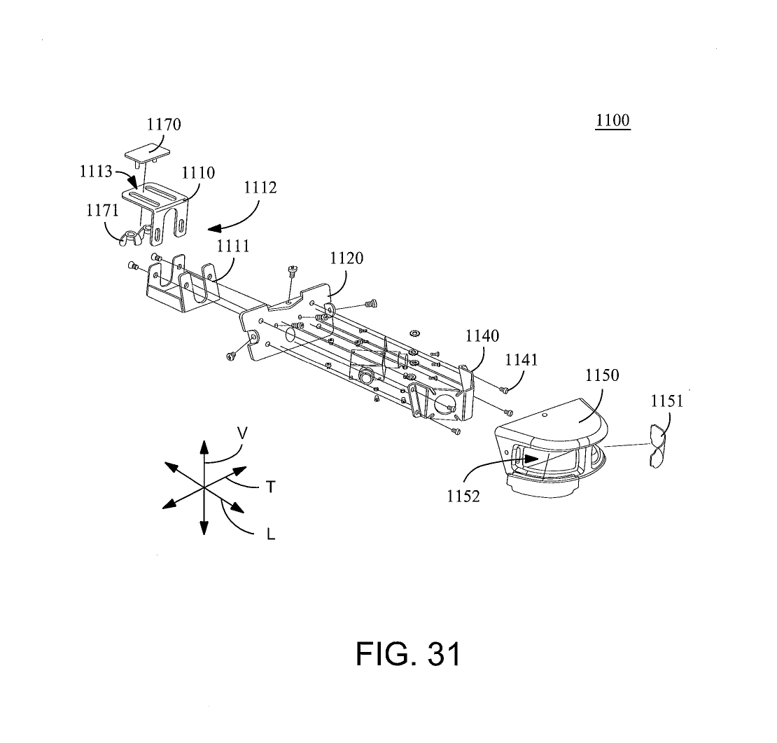

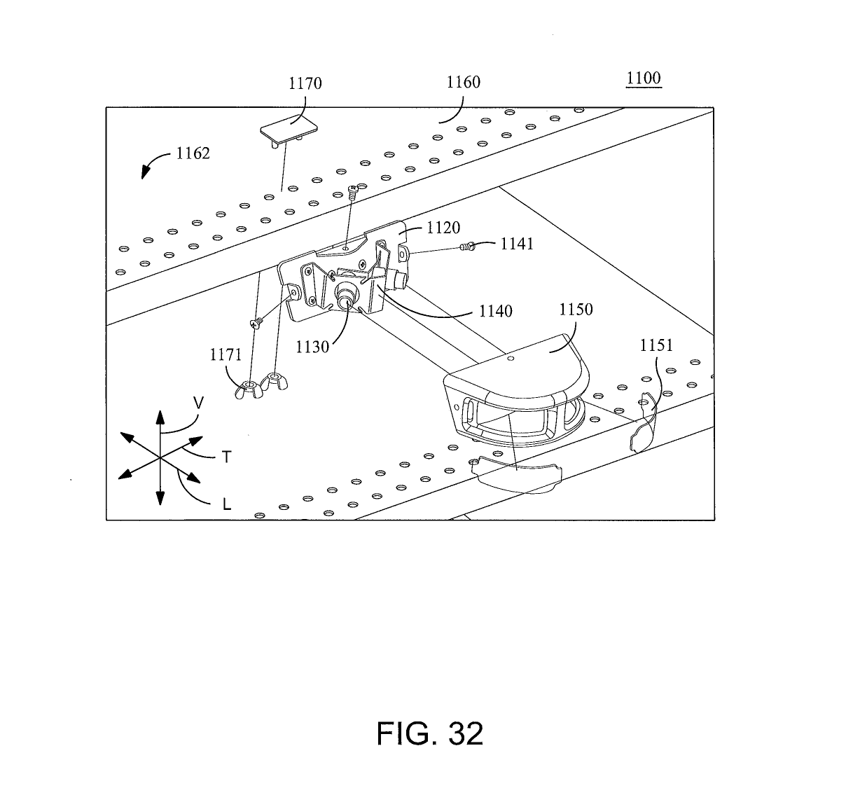

FIGS. 31-32 illustrate an exemplary monitoring device mounting system 1100 according to an exemplary embodiment of the present disclosure. Specifically, FIG. 31 depicts the mounting system 1100 and FIG. 32 depicts the mounting system 1100 in an exploded view.

Referring to FIGS. 31-32, monitoring device mounting system 1100 can be provided to mount a monitoring device to a pre-existing structure for premises monitoring such as theft deterrence and/or detection. The mounting system 1100 can include a rear bracket 1112, a rear camera mounting plate 1120, a camera assembly 1130, a camera mounting bracket 1140, and a housing 1150.

The rear bracket 1112 can include a first mounting portion 1110 having a planar portion 1113 that can be in contact with shelf 1160. Second mounting portion 1111 of the rear bracket can include tabs that couple with the first mounting portion 1110 and the rear camera mounting plate 1120. Camera assembly 1130 can include any type of camera such as a high resolution analog camera. The camera assembly 1130 can include any number of cameras and having any type of arrangement. For instance, camera assembly 1130 can include one or two cameras positioned to monitor the area in the vicinity of the mounting system 1100. The camera arrangement 1130 can be secured using a camera mounting bracket 1140. Each camera of the camera arrangement 1130 can pass through a portion of the camera mounting bracket 1140 and the camera mounting bracket 1140 can be coupled with the rear camera mounting plate 1120 to secure the camera assembly 1130 in place using fasteners 1141.

Housing 1150 can be formed of any material to provide protection for the mounting system 1100. Housing 1150 defines a chamber 1152 for receipt of camera assembly 1130. The housing 1150 can have any shape, arrangement, and/or configuration to house camera arrangement 1130. Protective lenses 1151 can be coupled within housing 1150.

The mounting system 1100 can be mounted to shelf 1160 using a coupling plate 1170 that rests on a top surface 1162 of shelf 1160. The coupling plate 1170 can include at least one protrusion, such as a threaded protrusion, that can pass through a pre-fabricated support such as shelf 1160. A fastener 1171 can be couple with the protrusions of the coupling plate 1170 to secure the mounting system 1100 to the shelf 1160. The coupling plate 1170 can have any shape, configuration, and/or arrangement to provide support and a coupling configuration to secure the mounting system to a pre-existing support structure while minimizing interference with products displayed on the pre-existing support.

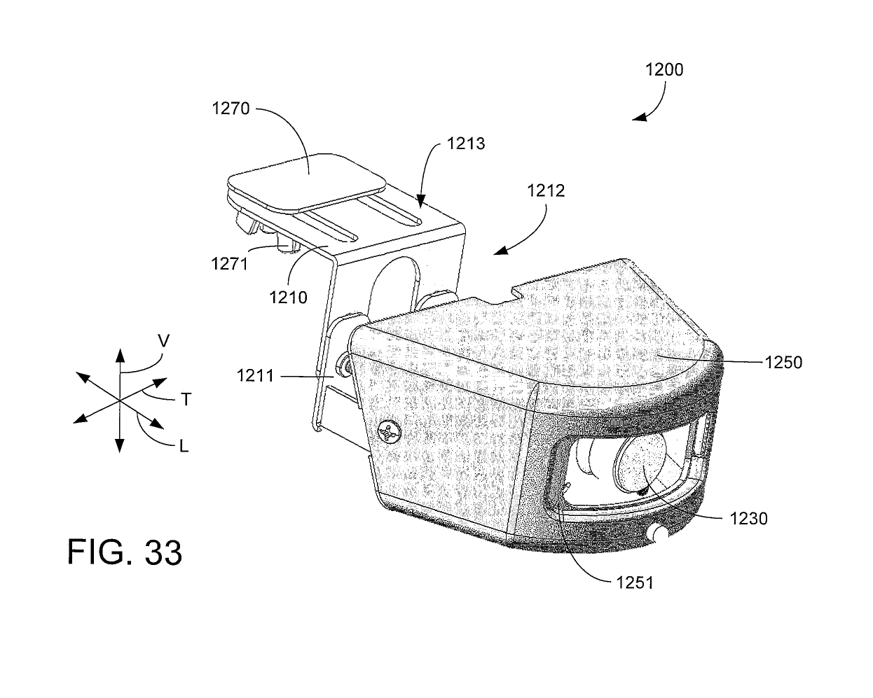

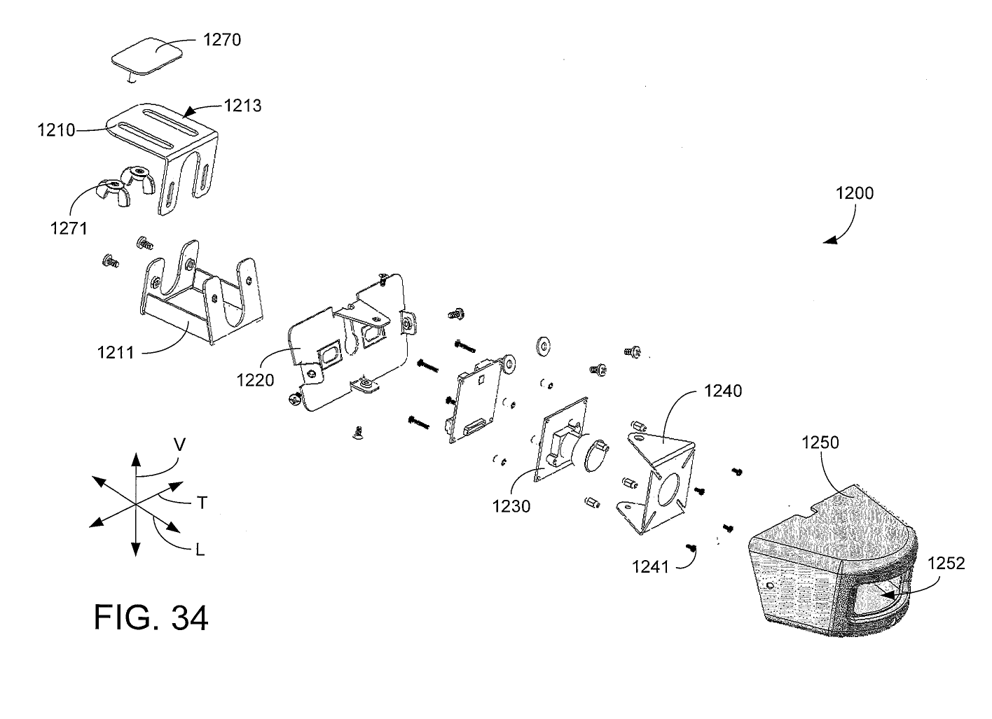

FIGS. 33-34 illustrate an exemplary monitoring device mounting system generally 1200 according to an exemplary embodiment of the present disclosure. Specifically, FIG. 33 depicts the mounting system 1200 and FIG. 34 depicts the mounting system 1200 in an exploded view.

Referring to FIGS. 33-34, monitoring device mounting system 1200 can be provided to mount a monitoring device to a pre-existing structure for premises monitoring such as theft deterrence and/or detection. The mounting system 1200 can include a rear bracket 1212, a rear camera mounting plate 1220, a camera assembly 1230, a camera mounting bracket 1240, and a housing 1250.

The rear bracket can include a first mounting portion 1210 having a planar portion 1213 that can be in contact with a shelf. Second mounting portion 1211 of the rear bracket can include tabs that couple with the first mounting portion 1210 and the rear camera mounting plate 1220. Camera assembly 1230 can include any type of camera such as a high resolution analog or other camera (details of which form no particular part of the present disclosure). The camera assembly 1230 can have any type of arrangement. For instance, camera assembly 1230 can include one camera positioned to monitor the area in the vicinity of the mounting system 1200. The camera arrangement 1230 can be secured using a camera mounting bracket 1240. The camera of the camera arrangement 1230 can pass through a portion of the camera mounting bracket 1240 and the camera mounting bracket 1240 can be coupled with the rear camera mounting plate 1220 to secure the camera assembly 1230 in place using fasteners 1241.

Housing 1250 can be formed of any material to provide protection for the mounting system 1200. Housing 1250 defines a chamber 1252 for receipt of camera assembly 1230. The housing 1250 can have any shape, arrangement, and/or configuration to house camera arrangement 1230. Protective lenses 1251 can be coupled within housing 1250.

The mounting system 1200 can be mounted to a shelf using a coupling plate 1270 that rests on a top surface of the shelf. The coupling plate 1270 can include at least one protrusion, such as a threaded protrusion, that can pass through a pre-fabricated support such as the shelf. A fastener 1271 can be coupled with the protrusions of the coupling plate 1270 to secure the mounting system 1200 to the shelf. The coupling plate 1270 can have any shape, configuration, and/or arrangement to provide support and a coupling configuration to secure the mounting system to a pre-existing support structure while minimizing interference with products displayed on the pre-existing support.

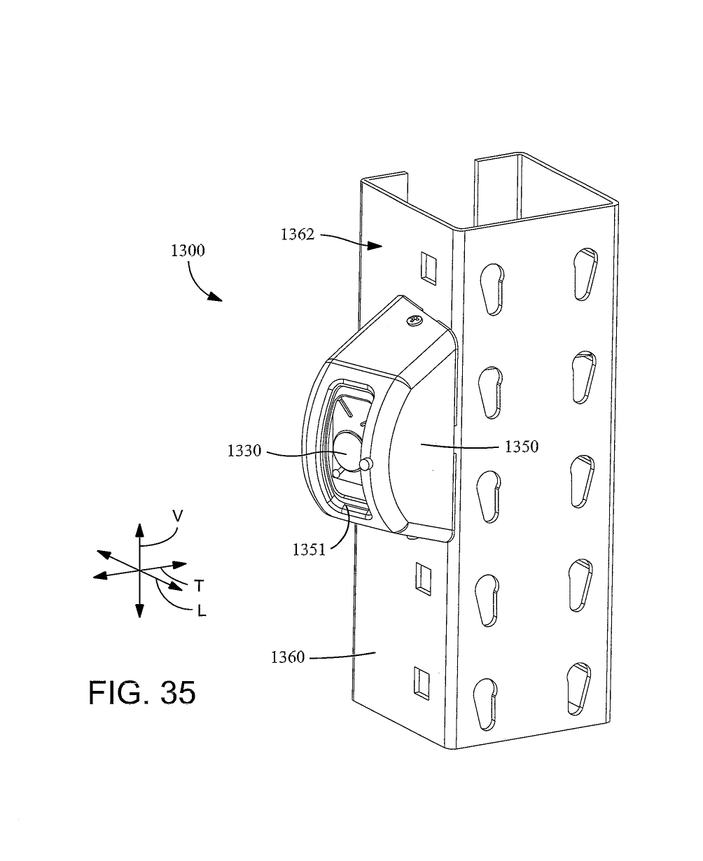

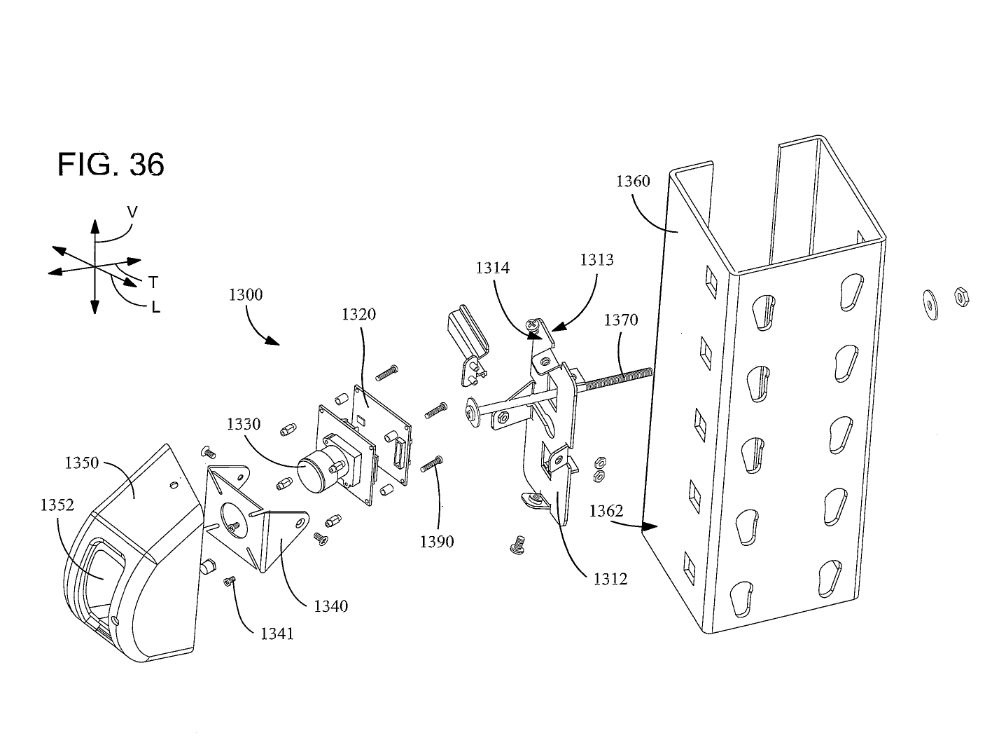

FIGS. 35-36 illustrate an exemplary monitoring device mounting system generally 1300 according to an exemplary embodiment of the present disclosure. Specifically, FIG. 35 depicts the mounting system 1300 and FIG. 36 depicts the mounting system 1300 in an exploded view.

Referring to FIGS. 35-36, monitoring device mounting system 1300 can be provided to mount a monitoring device to a pre-existing structure for premises monitoring such as theft deterrence and/or detection. The mounting system 1300 can include a display mounting bracket or rear bracket 1312, a camera mounting plate 1320, a camera assembly 1330, a camera mounting bracket 1340, and a housing 1350.

The rear bracket 1312 has a rear, planar portion 1313 and a front, planar portion 1314. Rear, planar portion 1313 is in contact with post 1360. Rear bracket 1312 is coupled to the rear camera mounting plate 1320 with fasteners 1390 at front, planar portion 1314. Camera assembly 1330 can include any type of camera such as a high resolution analog or other camera (details of which form no particular part of the present disclosure). The camera assembly 1330 can have any type of arrangement. For instance, camera assembly 1330 can include one camera positioned to monitor the area in the vicinity of the mounting system 1300. The camera arrangement 1330 can be secured using a camera mounting bracket 1340.

The camera of the camera arrangement 1330 can pass through a portion of the camera mounting bracket 1340 and the camera mounting bracket 1340 can be coupled with the rear camera mounting plate 1320 to secure the camera assembly 1330 in place using fasteners 1341.

Housing 1350 can be formed of any material to provide protection for the mounting system 1300. Housing 1350 defines a chamber 1352 for receipt of camera assembly 1330, rear bracket 1312, rear camera mounting plate 1320, and/or camera mounting bracket 1340. The housing 1350 can have any shape, arrangement, and/or configuration to house camera arrangement 1330. Protective lenses 1351 can be coupled within housing 1350. The mounting system 1300 can be mounted to post 1360 using a bolt 1370 that extends through post 1360 and rear bracket 1312. The present written description uses examples to disclose the presently disclosed subject matter, including the best mode, and also to enable any person skilled in the art to practice the presently disclosed subject matter, including making and using any devices or systems and performing any incorporated, corresponding, or related methods. While the presently disclosed subject matter has been described in detail with respect to specific embodiments thereof, it will be appreciated that those skilled in the art, upon attaining an understanding of the foregoing, may readily adapt the present technology for alterations or additions to, variations of, and/or equivalents to such embodiments. Accordingly, the scope of the present disclosure is by way of example rather than by way of limitation, and the subject disclosure does not preclude inclusion of such modifications, variations, and/or additions to the presently disclosed subject matter as would be readily apparent to one of ordinary skill in the art.

What is claimed is:

1. A monitoring device mounting system for supporting a monitoring device on a display, the monitoring device mounting system defining a vertical direction, a lateral direction, and a transverse direction, the vertical, lateral, and transverse directions being mutually perpendicular, the monitoring device mounting system comprising:
a monitoring device housing for supporting the monitoring device thereon;
support arm means for supporting said monitoring device housing; and
mounting bracket means for mounting said support arm means to the display.

2. The monitoring device mounting system of claim 1, wherein said monitoring device housing comprises respective laterally spaced front and rear portions, said monitoring device housing front portion and said monitoring device housing rear portion having respective widths along the transverse direction, the width of said monitoring device housing front portion being less than the width of said monitoring device housing rear portion.

3. The monitoring device mounting system of claim 1, wherein said support arm means comprises respective laterally spaced first and second end portions, with said monitoring device housing mounted to said support arm first end portion and said mounting bracket means mounted at said support arm second end portion.

4. The monitoring device mounting system of claim 3, wherein said support arm first and second end portions each extend longitudinally along the vertical direction.

5. The monitoring device mounting system of claim 1, wherein said mounting bracket means comprises a back brace and a front brace mounted to each other, with said back brace and said front brace having respective coplanar bottom surfaces, configured for resting on a top surface of an associated shelf.

6. The monitoring device mounting system of claim 1, wherein said mounting bracket means comprises a plurality of projections mounted to said mounting bracket means, each projection of said projections configured for receipt within a respective one of a plurality of holes defined by the display.

7. The monitoring device mounting system of claim 1, wherein said mounting bracket means defines holes for receipt of fasteners.

8. The monitoring device mounting system of claim 1, wherein said fasteners include a plate having projections that extend downwardly along the vertical direction, the projections of said plate insertable through the display and the holes of said mounting bracket means.

9. The monitoring device mounting system of claim 1, wherein said mounting bracket means comprises a pair of brackets having respective top surfaces, configured for positioning on a bottom surface of an associated shelf.

10. The monitoring device mounting system of claim 1, wherein said support arm means comprises a first portion and a second portion, said first portion slidably received within said second portion such that said second portion supports said first portion, said monitoring device housing mounted to said first portion.

11. The monitoring device mounting system of claim 1, wherein said mounting bracket means has a back surface and a plurality of projections mounted at the back surface, said projections configured for receipt within openings defined by the display.

12. The monitoring device mounting system of claim 1, wherein said mounting bracket means is configured for mounting said support arm means to existing features of the display.

13. The monitoring device mounting system of claim 1, wherein said mounting bracket means is configured for mounting said support arm means to the display without modifying the display.

14. A monitoring device mounting system for supporting a monitoring device on a display, the monitoring device mounting system defining a vertical direction, a lateral direction, and a transverse direction, the vertical, lateral, and transverse directions being mutually perpendicular, the monitoring device mounting system comprising:
a monitoring device housing for supporting the monitoring device thereon; and
mounting bracket means for mounting said monitoring device housing to the display.

15. The monitoring device mounting system of claim 14, wherein said mounting bracket means comprises a front plate mounted to a transversely extending top plate, configured for resting on a top surface of the display.

16. The monitoring device mounting system of claim 14, wherein said mounting bracket means has a top surface, configured for selective mounting on a bottom surface of an associated shelf.

17. The monitoring device mounting system of claim 16, wherein said mounting bracket means comprises a top plate defining the top surface, a bottom plate spaced apart from said top plate along the vertical direction, and a vertically extending side plate extending between and connecting said top plate and said bottom plate.

18. The monitoring device mounting system of claim 14, wherein said mounting bracket means comprises a front mounting bracket and a rear mounting bracket having respective transversely spaced rear surfaces, configured for resting on the display, said front and rear mounting brackets mounted to each other.

19. The monitoring device mounting system of claim 14, wherein said mounting bracket means comprises a display mounting bracket having respective transversely spaced front and back surfaces, the display mounting bracket back surface configured for resting on the display.

20. The monitoring device mounting system of claim 19, wherein said mounting bracket means comprises a camera mounting bracket mounted to said display mounting bracket at the display mounting bracket front surface and a camera housing mounted to said display mounting bracket and defining a chamber, said display mounting bracket and said camera mounting bracket disposed within the chamber of said camera housing.

21. The monitoring device mounting system of claim 14, wherein said mounting bracket means is configured for mounting said monitoring device housing to existing features of the display.

22. The monitoring device mounting system of claim 14, wherein said mounting bracket means is configured for mounting said monitoring device housing to the display without modifying the display.

23. A monitoring device mounting system for supporting a monitoring device on shelf of a display, the monitoring device mounting system defining a vertical direction, a lateral direction, and a transverse direction, the vertical, lateral, and transverse directions being mutually perpendicular, the monitoring device mounting system comprising:
a monitoring device housing for supporting the monitoring device thereon;
a support arm having respective laterally spaced first and second end portions, with said monitoring device housing mounted to said support arm first end portion; and
a mounting bracket configured for selective mounting on a top surface of an associated shelf, with said mounting bracket mounted at said support arm second end portion, said mounting bracket having a back brace and a front brace mounted to each other, with said back brace and said front brace having respective coplanar bottom surfaces, configured for resting on the top surface of the associated shelf.
